(19) United States
(12) Patent Application Publication
(10) Pub. No.: US 2015/0287053 A1
(43) Pub. Date: Oct. 8, 2015

(54) SYSTEM AND METHOD FOR TRACKING CONSUMER HABITS AT A VENUE

(71) Applicant: FANS ENTERTAINMENT INC., Montréal (CA)

(72) Inventor: Benoit Fredette, Montreal (CA)

(21) Appl. No.: 14/437,555

(22) PCT Filed: Oct. 23, 2013
(86) PCT No.: PCT/CA2013/000910

§ 371 Date: Apr. 22, 2015

Related U.S. Application Data
(60) Provisional application No. 61/717,277, filed on Oct. 23, 2012.

(51) Int. Cl. G06Q 30/02

(52) U.S. Cl. CPC G06Q 30/0201

(57) ABSTRACT

There is provided a system and method for tracking consumer habits at a venue. First request data indicative of a first request for at least one of a first plurality of products offered at the venue by a first service is received. Second request data indicative of a second request for at one of a second plurality of products offered at the venue by a second service is received. The first request data is correlated with the second request data to determine a relationship between a first consumption of the first plurality of products and a second consumption of the second plurality of products. Correlation data indicative of the relationship is then output.

### CROSS-REFERENCE TO RELATED APPLICATIONS

This patent application claims priority under 35 USC §119(e) of U.S. provisional Application Ser. No. 61/717,277, filed on Oct. 23, 2012, the contents of which are hereby incorporated by reference.

### TECHNICAL FIELD

The present invention relates to the field of providing services to consumers at a venue and tracking the consumers' habits at a venue.

### BACKGROUND OF THE ART

In order to drive sales and consumer retention, it may be desirable to tailor the products and services offered to the habits of consumers. For this purpose, it may be useful to improve consumer insight by acquiring information, such as statistics, about client behavior, needs, and other preferences. This is especially true when attempting to enhance the experience of clients at entertainment, sports, and other venues. However, the large attendance at such venues may hinder the tracking of consumption habits. In addition, in these venues, consumption habits are typically analyzed based on sales data and it is difficult to read the consumers' thinking or decision-making process when analyzing such data. As such, targeted content offering may be difficult to achieve in such a context.

There is therefore a need for an improved system and method for tracking consumer habits at a venue.

### SUMMARY

In accordance with a first broad aspect, there is provided a system for tracking consumer habits at a venue, the system comprising a memory; a processor; and at least one application stored in the memory and executable by the processor for receiving a first request signal comprising first request data indicative of a first request for one of a first plurality of products offered at the venue by a first service, receiving a second request signal comprising second request data indicative of a second request for one of a second plurality of products offered at the venue by a second service, correlating the first request data with the second request data to determine a first relationship between the first request and the second request, and outputting a control signal indicative of the first relationship.

In some embodiments, the at least one application is executable by the processor for receiving an event signal comprising event data indicative of an event occurring at the venue, the first request and the second request made during occurrence of the event, correlating at least one of the first request data and the second request data with the event data to determine at least one activity related to the event and corresponding to at least one of the first request and the second request, establishing a second relationship between the at least one activity and the at least one of the first request and the second request, and outputting the control signal indicative of the second relationship.

In some embodiments, the at least one application is executable by the processor for correlating at least one of the first request data and the second request data with the event data to determine the at least one activity having occurred during a course of the event prior to at least one the first and the second request being made and to determine the second comprising a sequential relation between the at least one activity and at least one of the first request and the second request.

In some embodiments, the at least one application is executable by the processor for determining at least one action to be taken in accordance with at least one of the first and the second relationship and for outputting the control signal comprising insight data indicative of the at least one action.

In some embodiments, the memory has stored therein a plurality of identifiers each uniquely identifying a corresponding one of a plurality of attendees at the venue and having associated therewith at least one attribute for the corresponding one of the plurality of attendees, and wherein the at least one application is executable by the processor for receiving the first request data and the second request data comprising a selected one of the plurality of identifiers, retrieving from the memory the at least one attribute associated with the selected one of the plurality of identifiers, and determining the at least one action in accordance with the at least one attribute.

In some embodiments, the memory has stored therein content for presentation on at least one mobile device during a course of the event, the at least one mobile device communicable with the processor and the memory over a network, and wherein the at least one application is executable by the processor for determining the at least one action comprising controlling at least one of a sequence, a timing, and a duration of the presentation of the content.

In some embodiments, the memory has stored therein a plurality of the content comprising at least one of an advertisement, a product offering, replay content, and interactive content and wherein the at least one application is executable by the processor for determining the at least one action comprising selecting a given one of the plurality of the content for presentation on the at least one mobile device.

In some embodiments, the at least one application is executable by the processor for receiving the first request data and the second request data each indicative of the request for at least one of accessing information about the corresponding one of the first and the second plurality of products and consuming the corresponding one of the first and the second plurality of products.

In some embodiments, the memory has stored therein past request data indicative of past requests for the one of the first and the second plurality of products and wherein the at least one application is executable by the processor for retrieving from the memory the past request data and comparing the first request data and the second request data to the retrieved past request data for identifying a pattern in the consumption of the corresponding one of the first and the second plurality of products.

In some embodiments, the at least one application is executable by the processor for identifying the pattern comprising at least one of a type, a number, a frequency, and a sequence of requests for the corresponding at least one of the first and the second plurality of products.

In some embodiments, the at least one application is executable by the processor for receiving the first request signal and the second request signal each comprising location data indicative of a location within the venue of a user having made the request and for correlating the location data with at least one of the event data, the first request data, and the second request data to determine first and the second relationship.

In some embodiments, the location data comprises seat location indicia uniquely identifying a selected one of plurality of physical spaces of the venue, the selected one of plurality of physical spaces uniquely assigned to the user.

In accordance with a second broad aspect, there is provided a computer-implemented method for tracking consumer habits at a venue, the method comprising receiving a first request signal comprising first request data indicative of a first request for one of a first plurality of products offered at the venue by a first service; receiving a second request signal comprising second request data indicative of a second request for one of a second plurality of products offered at the venue by a second service; correlating the first request data with the second request data to determine a first relationship between the first request and the second request; and outputting control signal indicative of the first relationship.

In some embodiments, the method further comprises receiving an event signal comprising event data indicative of an event occurring at the venue, the first request and the second request made during occurrence of the event, correlating at least one of the first request data and the second request data with the event data to determine at least one activity related to the event and corresponding to at least one of the first request and the second request, establishing a second relationship between the at least one activity and the at least one of the first request and the second request, and outputting the control signal indicative of the second relationship.

In some embodiments, the at least one of the first request data and the second request data is correlated with the event data to determine the at least one having occurred during a course of the event prior to at least one the first and the second request being made and to determine the second relationship comprising a sequential relation between the at least one activity and at least one of the first request and the second request.

In some embodiments, the method further comprises determining at least one action to be taken in accordance with the at least one of the first and the second relationship and outputting the control signal comprising insight data indicative of the at least one action.

In some embodiments, receiving the first request data and the second request data comprises receiving a selected one of a plurality of identifiers stored in a memory, each one of the plurality of identifiers uniquely identifying a corresponding one of a plurality of attendees at the venue and having associated therewith at least one attribute for the corresponding one of the plurality of attendees, the method further comprising retrieving from the memory the at least one attribute associated with the selected one of the plurality of identifiers, and determining the at least one action in accordance with the at least one attribute.

In some embodiments, determining the at least one action comprises controlling at least one of a sequence, a timing, and a duration of presentation of a content on at least one mobile device during a course of the event.

In some embodiments, determining the at least one action comprising selecting a given one of a plurality of the content for presentation on the at least one mobile device, the plurality of the content comprising at least one of an advertisement, a product offering, replay content, and interactive content.

In some embodiments, the method further comprises retrieving from a memory past request data indicative of past requests for the at least one of the first and the second plurality of products and comparing the first request data and the second request data to the retrieved past request data for identifying a pattern in the consumption of the corresponding at least one of the first and the second plurality of products.

In some embodiments, identifying the pattern in the consumption comprising identifying at least one of a type, a number, a frequency, and a sequence of requests for the corresponding at least one of the first and the second plurality of products.

In some embodiments, the first request signal and the second request signal each comprise location data indicative of a location within the venue of a user having made the request, the method further comprising correlating the location data with at least one of the event data, the first request data, and the second request data to determine first and the second relationship.

In accordance with a third broad aspect, there is provided a computer readable medium having stored thereon program code executable by a processor for tracking consumer habits at a venue, the program code executable for receiving a first request signal comprising first request data indicative of a first request for one of a first plurality of products offered at the venue by a first service; receiving a second request signal comprising second request data indicative of a second request for one of a second plurality of products offered at the venue by a second service; correlating the first request data with the second request data to determine a first relationship between the first request and the second request; and outputting a control signal indicative of the first relationship.

### BRIEF DESCRIPTION OF THE DRAWINGS

Further features and advantages of the present invention will become apparent from the following detailed description, taken in combination with the appended drawings, in which:

FIG. 1 is a schematic diagram of a system for providing services at a venue, in accordance with an illustrative embodiment of the present invention;

FIG. 2a is a schematic diagram of an application running on the processor of FIG. 1;

FIG. 2b is a schematic diagram of the selection tracking module of FIG. 2a;

FIG. 2c is a schematic diagram of the correlation module of FIG. 2b;

FIG. 3a is a flowchart of a method for tracking consumer habits at a venue, in accordance with an illustrative embodiment of the present invention;

FIG. 3b is a flowchart of the step of FIG. 3a of recording selection data;

FIG. 3c is a flowchart of the step of FIG. 3a of correlating selection data;

FIG. 4a is a screen capture of a user interface for registering with the system of FIG. 1;

FIG. 4b is a screen capture of a user interface for logging into the system of FIG. 1;

FIG. 4c is a screen capture of a user interface loading ticket or seat information, in accordance with an illustrative embodiment;

FIG. 4d is a screen capture of a user interface for viewing venue services and selecting the concession service, in accordance with an illustrative embodiment;

FIG. 4e is a screen capture of a user interface for viewing food/beverage categories for the concession service of FIG. 4d and selecting to view beer products;

FIG. 4f is a screen capture of a user interface for viewing beer items for the beer category of FIG. 4e;

FIG. 4g is a screen capture of a user interface for placing an order for a given one of the beer items of FIG. 4f;

FIG. 4h is a screen capture of a user interface for presenting an ordering screen for the beer item of FIG. 4g;

FIG. 4i is a screen capture of a user interface for presenting a confirmation screen for the order of FIG. 4h;

FIG. 4j a screen capture of a user interface for viewing venue services and selecting the event info service, in accordance with an illustrative embodiment;

FIG. 4k a screen capture of a user interface for viewing venue services and selecting the fan store service, in accordance with an illustrative embodiment;

FIG. 4l is a screen capture of a user interface for viewing product categories for the fans store service of FIG. 4k and selecting to view hat products; and

FIG. 5 is a table of selection data entries stored by the service selection recording module and the product selection recording module of FIG. 2b.

It will be noted that throughout the appended drawings, like features are identified by like reference numerals.

### DETAILED DESCRIPTION

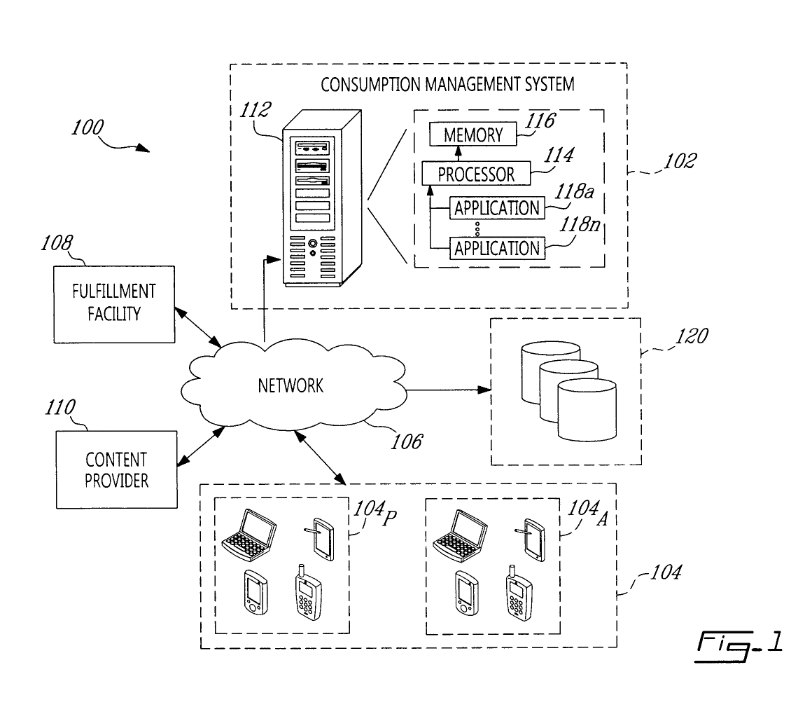

Referring to FIG. 1, a system 100 for providing services at a venue will now be described. Although the description below refers to a stadium or arena, it should be understood that other entertainment venues, such as theaters, concerts halls, and the like, may apply. It should also be understood that other venues, such as hospitality or retail venues may apply. For example, the system 100 may be used at hotels, resorts, camps, amusement parks, relaxation centers, country clubs, convalescence centers, retirement communities, healthcare centers, convention centers, retail locations, and the like. Although the description herein refers to a live event, such as a sports game, it should be understood that various events may apply. For example, the event may relate to an activity, such as a massage, downhill skiing, shopping, or the like, undertaken by the patron at a hospitality or retail venue.

The system 100 illustratively comprises a consumption management system 102. The system 102 is adapted to communicate with a plurality of devices 104 via a network 106, such as the Internet, a cellular network, Wi-Fi, or others known to those skilled in the art. The devices 104 may comprise any device, such as a laptop computer, a personal digital assistant (PDA), a smartphone, or the like, adapted to communicate over the network 106. The devices 104 may further comprise mobile patron devices 104_{P} that enable patrons present at the venue, to access the consumption management system 102 in order to obtain information about a variety of products and/or services offered at the venue and/or place orders for such products and/or services. For example, and as will be discussed further below, patrons may, using their devices 104_{P}, order food, beverages, clothing, and other merchandise available at the venue. Using their devices 104_{P}, patrons may further gain access to a variety of entertainment services, such as live event content, replay content, interactive content, event information, notifications services, and the like. The devices 104 may also comprise administrator devices 104_{A} that enable administrators, such as technicians, operators, event organizers, and other staff associated with the fulfillment facility 108, the content provider 110, and/or the venue, to gain access to analysis data produced by the system 102, as will be discussed further below.

When patrons place orders for a given product, such as food, beverages or clothing, the orders may be fulfilled at at least one fulfillment facility 108. For example, when dealing with orders for food or beverages, the fulfillment facility 108 may be a concession stand, kitchen, bar, and the like, communicating with the system 102 via the network 106. As used herein, the term “concession” refers to a place where patrons or consumers can purchase refreshments, e.g. food and beverages, while at the venue. The term “concession” may also refer to an inventory stockroom, or the like, where the refreshments are prepared and where delivery staff associated with the fulfillment facility 108 stock up. When dealing with orders for products other than food/beverages, the fulfillment facility 108 may be a kiosk, inventory stockroom, or the like, holding the products. It should be understood that patrons may pick up their order at the fulfillment facility 108 rather than having the order delivered to their seat. In addition, for products other than food/beverages, patrons may pick up their order at a main retail store associated holding the ordered product, the store being typically located outside of the venue.

Although a single fulfillment facility 108 has been shown for illustrative purposes, it should be understood that the system 100 may comprise a plurality of fulfillment facilities 108. It should also be understood that the fulfillment facility 108 may be a fixed sales emplacement or a mobile sales emplacement, e.g. a food cart. The fulfillment facility 108 may then be located outside the venue, although desirably in close proximity thereto (e.g. near the entrance to the venue).

Upon processing the order at the fulfillment facility 108, one or more staff members may deliver the order to the patron. Such staff members include, but are not limited to, servers, runners, waiters, and other personnel associated with the fulfillment facility 108 and/or the venue. In one embodiment, each staff member may also be provided with a device 104_{A} for assisting them to better service the patron. As such, the device 104_{A} may display information about the patron's order and other pending orders as well as patron information, e.g. patron's name, seat number, billing information, and the like.

In some embodiments, the system 102 may require users, e.g. patrons, to log in or otherwise gain authorized access to the system 102 through the use of a unique identifier. For this purpose, patrons illustratively register with the system 102 by completing an application, thereby creating a unique profile or account. This may be done by accessing a website associated with the system 102 and/or venue using the patron's device 104_{P} for instance. If a patron wishes for his/her future orders or purchases to be paid electronically, i.e. without any bill being physically delivered to the patron, payment information may be provided upon completion of the profile. For example, the patron may provide data associated with an account he/she holds at a financial entity, such as a bank, enter a credit card number that may be used for processing payments, or information related to redeemable corporate vouchers that may be used to purchase goods at the venue. Once registration is complete, each patron is illustratively provided with a unique identifier, such as a username and password, associated with his/her profile. The identifier may be used to verify the identity of the patron and for processing payments. The patron may then access the system 102 by logging on to the website using the identifier.

Once having been granted access to the system 102, the patron may subsequently load therein information about their ticket and/or seat number at the chosen venue. This ticket information may be provided subsequent to the patron scanning a portion or the entirety of their ticket. In particular, at least the ticket number and seat number may then be obtained from a ticket issuer and loaded into the system 102 and/or the databases 120 further to the scanning process. The information may also be manually entered by the patron using suitable interface elements (not shown) presented on the device 104_{P}. Alternatively, the system 102 may be installed on the device 104 as a software application, which may be launched by the patron or other user on the device 104 for accessing the system 102. It should be understood that the system 102 may be accessed by multiple users simultaneously. In this manner, a large volume of consumers may be supported. It should also be understood that the patron may log into the system 102 using an identifier associated with an online social network or social networking application (e.g. Facebook™, Google+™, Twitter™ or the like) to which the patron has subscribed.

As will be discussed further below, in order to track consumption habits of patrons at the venue, the consumption management system 102 may further communicate with a content provider 110 broadcasting the event to the patrons. As know to those skilled in the art, live content may be viewed by patrons at the setting, e.g. scene, stage, field, or the like, of the event. Audio and video footage of the event may further be captured by cameras present at the venue and the resulting live content data may then be rendered by the content provider 110 to output devices, e.g. screens and speakers, provided at the venue. In addition, the live content data may be broadcasted by the content provider 110. The content provider 110 may further broadcast news feeds, highlights, and exclusive content (e.g. interviews, exclusive audio and video streams, etc.) related to the live event to the devices 104_{P}. The content provider 110 may also provide replays of video footage of the live event immediately or at any other time after the event has occurred. For example, instant replays may be presented on the devices 104_{P} during a break or lull in the live event. Replays may enable patrons to view passages of the event that were important or remarkable, passages, which were unclear on first sight, or any other passage of the event, as desired.

The content provider 110 may also provide advertisements and commercials content that is presented during intermissions or breaks in the live event or prior to presentation of the replays. In this manner, a variety of goods and services may be promoted to the patrons. The content provider 110 may further provide interactive content, such as crowd sourcing games, contests, quizzes, live surveys, chatroom services, notification services, interactive venue maps, and the like. The interactive content may be presented on the devices 104_{P} concurrently with or outside of the live event to foster user interaction and engagement. The content data provided by the content provider 110 may be tailored to the event, the venue, and/or the preferences of the patron, as indicated in their profile. Although the description herein refers to a live event, such as a sports game, it should be understood that various events may apply, as discussed above. The content data may therefore comprise calendar information, appointment information, and the like. Also, the content data may or may not be provided by the content provider 110.

Also, it should be understood that the content provider 110 may further comprise (or communicate with) a ticketing system (not shown), which may have access to information associated with a given ticket, e.g. patron's identification and/or seat number corresponding to a given ticket number. As discussed above, the ticket information may be obtained from the ticketing system further to the patron scanning their ticket. For this purpose, the ticketing system illustratively records (e.g. in the databases 120) the location and numbers of all seats for the venue, an identification of all tickets (and corresponding ticket numbers) issued for the event occurring at the venue, and an identification of each patron having purchased a ticket for the event.

The system 102 may comprise one or more server(s) 112. For example, a series of servers corresponding to a web server, an application server, and a database server may be used. These servers are all represented by server 112 in FIG. 1. The server 112 may comprise, amongst other things, a processor 114 coupled to a memory 116 and having a plurality of applications 118a, . . . , 118n running thereon. The processor 114 may access the memory 116 to retrieve data. The processor 114 may be any device that can perform operations on data. Examples are a central processing unit (CPU), a microprocessor, and a front-end processor. The applications 118a, . . . , 118n are coupled to the processor 114 and configured to perform various tasks as explained below in more detail. It should be understood that while the applications 118a, . . . , 118n presented herein are illustrated and described as separate entities, they may be combined or separated in a variety of ways. It should be understood that an operating system (not shown) may be used as an intermediary between the processor 114 and the applications 118a, . . . , 118n. Also, although the system 102 is described herein as comprising the processor 114 having the applications 118a, . . . , 118n running thereon, it should be understood that cloud computing may also be used. As such, the memory 116 and/or databases 120 may comprise cloud storage.

The memory 116 accessible by the processor 114 may receive and store data. The memory 116 may be a main memory, such as a high speed Random Access Memory (RAM), or an auxiliary storage unit, such as a hard disk or flash memory. The memory 116 may be any other type of memory, such as a Read-Only Memory (ROM), Erasable Programmable Read-Only Memory (EPROM), or optical storage media such as a videodisc and a compact disc.

One or more databases 120 may be integrated directly into the memory 116 or may be provided separately therefrom and remotely from the server 112 (as illustrated). In the case of a remote access to the databases 120, access may occur via any type of network 106, as indicated above. The databases 120 described herein may be provided as collections of data or information organized for rapid search and retrieval by a computer. The databases 120 may be structured to facilitate storage, retrieval, modification, and deletion of data in conjunction with various data-processing operations. The databases 120 may consist of a file or sets of files that can be broken down into records, each of which consists of one or more fields. Database information may be retrieved through queries using keywords and sorting commands, in order to rapidly search, rearrange, group, and select the field. The databases 120 may be any organization of data on a data storage medium, such as one or more servers. Information about the various content, services, and/or products provided at the venue and/or by the content provider 110 may be stored in the databases 120.

In one embodiment, the databases 120 are secure web servers and Hypertext Transport Protocol Secure (HTTPS) capable of supporting Transport Layer Security (TLS), which is a protocol used for access to the data. Communications to and from the secure web servers may be secured using Secure Sockets Layer (SSL). Identity verification of a user may be performed using usernames and passwords for all users. Various levels of access rights may be provided to multiple levels of users.

Alternatively, any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol).

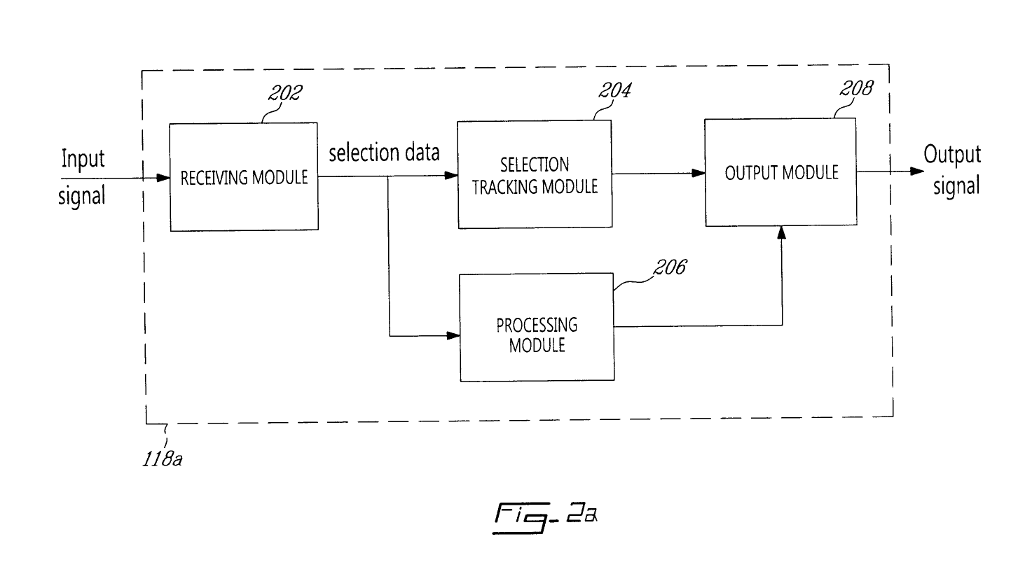

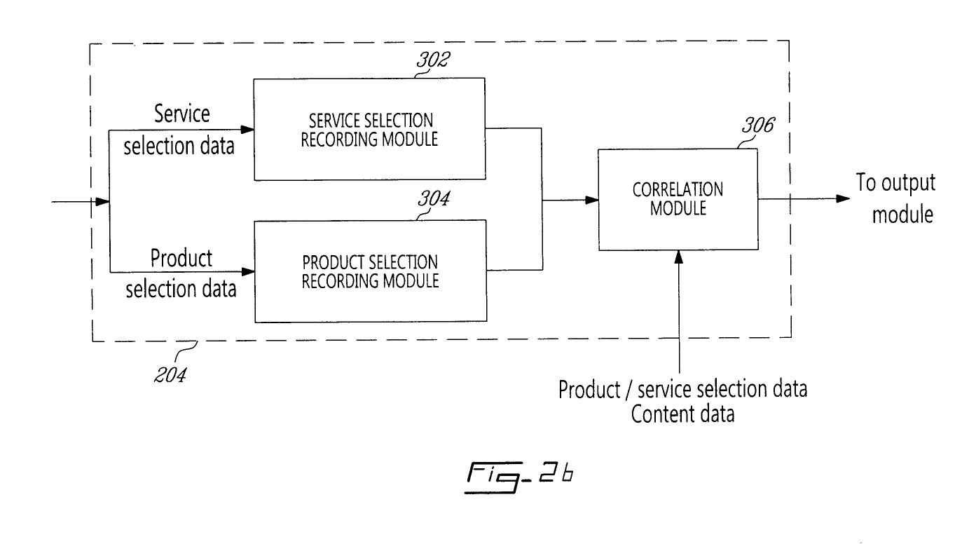

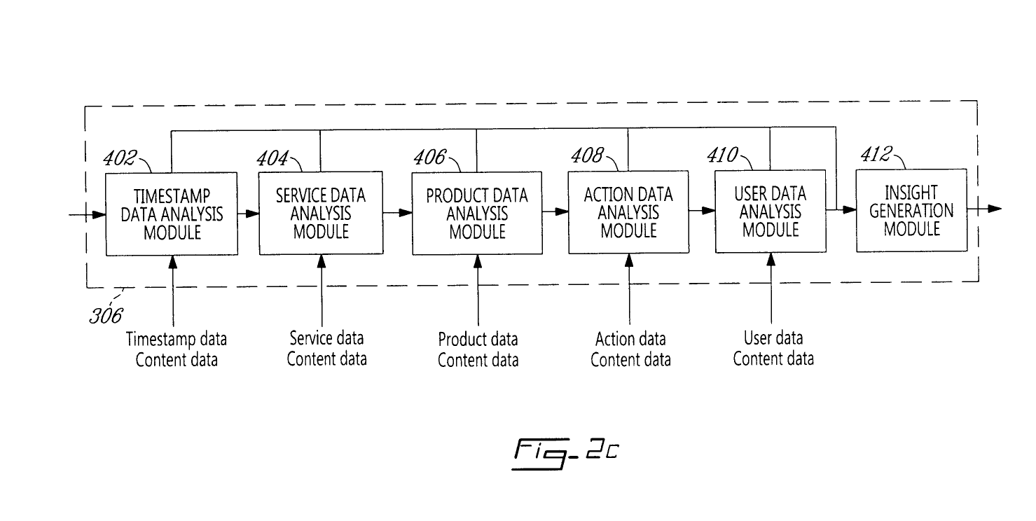

FIG. 2a is an exemplary embodiment of an application 118a running on the processor 114. The application 118a illustratively comprises a receiving module 202, a selection tracking module 204, a processing module 206, and an output module 208.

The receiving module 202 illustratively receives an input signal from a device 104_{P} used by a patron. As will be discussed further below, patrons may be presented on their devices 104_{P} with a user interface depicting the various services offered at the venue. The patron may then select or request a given service, resulting in presentation on the user interface of information detailing the various features or products provided for the selected venue service. Upon selecting a given feature or product, the patron may then have access to information thereabout. Upon selecting a product, the patron may also place an order for the product in addition to being provided with information thereabout. It should be understood that the services and the products/features associated therewith may be tailored to the venue, event, and/or preferences of the patron, as indicated in their profile. Although the description herein refers to selections or requests being made by a patron using their device 104_{P}, it should be understood that selections may also be received from the administrator devices 104_{A}. This may for example be the case if a staff member associated with the venue purchases a concession product prior to presentation of the live event.

Examples of venue services comprise, but are not limited to, concession services, fan store or fan club services, season ticket holder services, event information, live content, venue map, interactive content, live chat, upcoming events, notification services, social media integration, localization of social network friends present at the venue, parking management, suite management, fan cam, fundraising, charity lottery, silent auctions, loyalty programs, badges or ticket history, fine dining reservation services, gaming marking, and statistics. For the concession service, examples of products comprise, but are not limited to, hot dogs, pizza, pop corn, fries, chips, nachos, soft drinks, beer, and combos. It should be understood that additional products may be provided and that sub-products may further be associated with each product. For instance, the pizza product may comprise the all-dressed pizza, the vegetarian pizza, and other sub-products.

The input signal received at the receiving module 202 may thus comprise selection data indicative of a patron's selection of a venue service, i.e. service selection data, and of at least one product or sub-product associated with the selected venue service, i.e. product selection data. The receiving module 202 may then transmit the selection data to the selection tracking module 204, which may be used to track selections effected by patrons, as will be discussed further below. When the patron selects a given venue service and associated product or sub-product and further places an order for such a product or sub-product, the selection data may also be sent to the processing module 206. The processing module 206 may then process the patron's order. Such processing may include searching for a fulfillment facility 108 available and having the capacity to fulfill the order. The processing step effected by the processing module 206 may also include identifying an optimal route for delivering the patron's order and/or grouping orders in order subsets to ensure fast and efficient delivery when multiple orders are received. The processing step effected by the processing module 206 may further include processing a payment for the order using electronic payment means or any other suitable means known to those skilled in the art. The processing module 206 may for instance charge a credit card or financial account of the patron.

Once processing is completed, the processing module 206 may then send a control signal to the output module 208 for causing transmission of the order data to the identified fulfillment facility 108 as well as transmission of an order placement confirmation message to the patron's device 104_{P}. It should be understood that in cases where the order may be fulfilled by a facility, such as a retail store, located outside the venue, the control signal sent to the output module 208 may cause transmission of the order data to the outside facility rather than to the fulfillment facility 108. The output module 208 may then format the received data and generate an output signal for causing transmission of the formatted data to the patron devices 104_{P} and/or rendering on an interface, e.g. a screen, thereof. The output module 208 may transmit data to the devices 104_{P} and/or fulfillment facility 108 through instant push notifications sent via the network 106. Email, Short Message Service (SMS), Multimedia Messaging Service (MMS), instant messaging (IM), or other suitable communication means known to those skilled in the art may also apply.

It should be understood that the receiving module 202 may take into account the time interval between the reception of successive input signals to determine whether selection data should be transmitted to the selection tracking module 204 and/or the processing module 206 for processing. Indeed, an input signal may be generated as a result of a user inadvertently selecting a service or product via the user interface presented on their device 104_{P}. For example, if selection is made on a touchscreen, this may occur if the user's finger slipped and selected the wrong product. It may therefore be desirable to discriminate between erroneous and rightful input. For this purpose, the receiving module 202 may compare the time interval between inputs to a predetermined threshold, e.g. one (1) second. If the time interval between inputs is lower than the threshold, it may be determined that the user did not spend enough time considering the currently received selection. Thus, the receiving module 202 may conclude that an erroneous selection has been received. A signal may then be sent to the output module 208 to trigger the presentation on the device 104_{P} of a message prompting the user to confirm his/her selection. Otherwise, if the time interval between inputs is greater than the threshold, the receiving module 202 may conclude that a rightful selection has been made. Although any received input data is illustratively sent to the selection tracking module 204 and/or the processing module 206, whether erroneous or not, erroneous selections may be flagged in the received input data transmitted. The selection tracking module 204 and processing module 206 may therefore identify erroneous selections as non-meaningful and these selections may be excluded from analysis. In this manner, erroneous selections are illustratively not processed or analyzed to track consumer habits.

Referring to FIG. 2b, the selection tracking module 204 illustratively comprises a service selection recording module 302, a product selection recording module 304, and a correlation module 306. When service selection data is received at the receiving module 202, i.e. the selection effected by the patron relates to selection of a given venue service, the receiving module 202 may transmit the service selection data to the service selection recording module 302. When product selection data is received at the receiving module 202, i.e. the selection effected by the patron relates to selection of a given product or sub-product associated with a previously selected venue service, the receiving module 202 may transmit the product selection data to the product selection recording module 304. Upon receiving the service selection data and the product selection data, the service selection recording module 302 and the product selection recording module 304 may then store the received selection data in the memory 116 and/or databases 120.

The data may be stored by the service selection recording module 302 and the product selection recording module 304 by populating a plurality of entries or records in the memory 116 and/or databases 120, an entry being illustratively created each time new selection data is received. In particular, the service selection data stored may populate a venue service field with the service selection data. The data stored in the venue service field may indicate the type of venue service selected by the patron. The product selection recording module 304 may populate a product field and at least one sub-product field with the product selection data. The data stored in the product/sub-product fields may indicate the type of product or sub-product, if any, selected by the patron. It should be understood that, in some embodiments, the product selection recording module 304 may only save product data and not sub-product data. Indeed, in some cases, it may not be relevant to obtain information about the sub-products, e.g. type of pizza, selected by a patron as knowledge of the product, e.g. pizza, may be sufficient. Also, the number of selections effected by the patron using their device 104_{P} may be limited in some embodiments. As such, the entries stored by the product selection recording module 304 may or may not comprise a sub-product field. Also, it should be understood that in some embodiments, the selection data may be processed, e.g. analyzed, as it is received from a device 104_{P}, i.e. without having been previously recorded in the memory 116 and/or databases 120 by the service selection recording module 302 and the product selection recording module 304.

Each entry may further comprise user data identifying the patron having placed the order. For example, the patron's username or location, e.g. seat number, at the venue may be recorded. In addition, the service selection recording module 302 and the product selection recording module 304 may associate a standard timestamp with each entry. The standard timestamp data may indicate the standard time, e.g. the civil or local time indicated by standard clocks, at which the service or product selection data has been received from the patron device 104_{P}. The service selection recording module 302 and the product selection recording module 304 may further associate an event timestamp with each entry. The event timestamp data may indicate the event time at which the selection data has been received. This may be the case when the live event is a sports game or any other event having its own timing and duration, which may be determined by an independent clock or timer. In particular, a football game is typically divided into two (2) halves of thirty (30) minutes and four (4) quarters of fifteen (15) minutes. A game clock may then be used to keep track of the official time for the game and is illustratively set to 15:00 at the beginning of each quarter. The game clock may also be used to time the halftime period, which lasts twelve (12) minutes during the regular season. The game clock stops during breaks in the game, after incomplete passes, during time-outs, and while plays are being reviewed by the officials. It also stops at the two-minute warning at the tail end of each half (i.e. of the second and fourth quarters). As such, the game time clearly differs from the standard time and two (2) minutes on the game clock may correspond to six (6) minutes in standard time.

When selection data is received at the service selection recording module 302 and the product selection recording module 304, the latter may retrieve from the content provider 110, memory 116, and/or databases 120 the content data presented to the devices 104_{P} and/or at the venue. The retrieved content data illustratively provides event clock information indicative of the event (e.g. the official game time). The service selection recording module 302 and the product selection recording module 304 may then correlate the selection time with the event clock information to determine which moment of the event clock corresponds to the standard time at which the selection was made. The event timestamp data can then be generated and associated with each entry stored by the service selection recording module 302 and the product selection recording module 304. It should be understood that event timestamp data may not only comprise an event time corresponding to a given standard time but may optionally also comprise an indication of an action or activity having occurred at the event time. For instance, upon correlating the selection time with the event time, the service selection recording module 302 and the product selection recording module 304 may determine that at the given moment of the event clock, a specific action or activity (e.g. a goal) has occurred. An indication of the type of action or activity may then be associated with the event timestamp.

Moreover, the selection data may comprise an indication of the action associated with the selection effected by the patron. For example, the patron may select a given product for the sole purpose of viewing information, e.g. pricing, nutritional, or other relevant information, associated therewith. The patron may further select the product to place an order therefor. It should be understood that other actions, such as partaking in a live survey when an interactive service is selected, may also apply. As such, each entry stored by the service selection recording module 302 and the product selection recording module 304 may further comprise a field indicating the action, e.g. viewing, ordering, participating, or the like, associated with the patron's selection. It should also be understood that the selection recording module 302 may store other relevant information associated with the patron's selection. For example, data indicating the venue at which the selection was made may also be stored. Data indicating the patron's seat number, the name of the live event, or the amount of time a patron spent considering a given selection, e.g. viewing a given product, may also be recorded.

As will be discussed further below, once all selection data has been received from the patrons and stored by the service selection recording module 302 and the product selection recording module 304, the correlation module 306 may then retrieve from the memory 116 and/or databases 120 the stored selection data for analysis purposes. The stored selection data may comprise data recorded over a given timeframe for a plurality of events having occurred at the venue. As will be discussed below, the correlation module 306 may also retrieve content data from the content provider 110 and/or the databases 120. The correlation module 306 may then compile and correlate the retrieved data to identify consumption habits, patterns, and other trends at the venue. In particular, the correlation module 306 may analyze the data to identify a correlation between patron consumption at different venue services. For example, the correlation module 306 may identify that selection of a given product from a first venue service triggers the selection of another product associated with a second venue service. It should be understood that the service selection recording module 302 and the product selection recording module 304 may send the currently received service and product selection data to the correlation module 306. As a result, the correlation module 306 may continuously correlate the received selection data with previously recorded selection data retrieved from the memory 116 and/or databases 120. The results of the analysis performed by the correlation module 306 may then be stored in the memory 116 and/or databases 120 for future reference. The analysis results may further be sent to the output module 208 for rendering on the administrator devices 104_{A}. It should be understood that the analysis results may be compiled and presented in any suitable format, such as analysis reports, charts, tables, graphs, and the like. It should also be understood that, in some embodiments, the devices 104_{A} may access the system 102 to retrieve the analysis results instead of having the latter sent to the devices 104_{A} by the output module 208.

Referring to FIG. 2c, the correlation module 306 illustratively comprises a timestamp data analysis module 402, a service data analysis module 404, a product data analysis module 406, an action data analysis module 408, a user data analysis module 410, and an insight generation module 412. It should be understood that the analysis performed by the correlation module 306 may be implemented by one or more of the modules 402, 404, 406, 408, 410, and 412. It should also be understood that, depending on the type of correlation or analysis to be effected by the correlation module 306, additional modules may be provided.

The timestamp data analysis module 402 illustratively obtains timestamp data for each entry of the product and service selection data retrieved from the memory 116 and/or databases 120. The timestamp data analysis module 402 may then analyze the timestamp data to identify time-related patterns and other trends in consumption habits for the various venue services. For example, the timestamp data analysis module 402 may determine from analysis of the retrieved timestamp data the frequency at which patrons navigate from one venue service to the next. This may provide an indication as to which venue services are more popular among patrons. The timestamp data analysis module 402 may also determine from the timestamp data the frequency at which patrons select products and sub-products for a given venue service, such as the concession service, compared to the frequency at which they select products for another venue service, such as the fan store service. This may provide an indication as to how popular the products offered at each one of the venue services are. The frequency of selections may also provide an indication of the variety of product choices provided for a given venue service.

As discussed above, the timestamp data may comprise standard timestamp data, as indicated by a standard clock, and event timestamp data, as indicated by an event clock. The timestamp data analysis module 402 may then correlate the standard timestamp data with the event timestamp data to gain insight into the behavior of venue attendees when specific actions or activities related to the event occur. In particular, by comparing the standard timestamp data with the event timestamp data, the timestamp data analysis module 402 may correlate the timing of any selection made by a user with a timing of the event occurring at the venue. In this manner, the timestamp data analysis module 402 may determine what action or activity related to the event occurred at the moment a user made a given selection. The timestamp data analysis module 402 may further determine which action or activity led to a given selection. The correlation may then be stored in the memory 116, and/or databases 120.

For instance, the timestamp data analysis module 402 may determine from the correlation that when a fight occurs during a sports game, the frequency of product selection decreases. This may be due to the fact that users are busy looking at the fight and spending less time consulting the products offered at the fulfillment facility 108. Such information may be useful in determining how to adjust advertising, promotions, product offerings, and other content presented to users on the devices 104_{P}. Parameters including, but not limited to, a number, a sequence, a timing, and a duration of the content, may be adjusted. Indeed, advertising may be reduced at times where it is determined that the frequency of product selection typically decreases. The correlation made by the timestamp data analysis module 402 may further determine that, after a given action occurs in the event, users typically select specific content. For instance, when the event is a sports game, the correlation may enable to conclude that after a goal, users tend to select replays for viewing on their devices 104_{P}. When the event is a concert, the correlation may enable to conclude that users tend to select more beers after a rock song is played than after a jazz song. Presentation of content may then be targeted accordingly.

Moreover, using previous correlations between past selections and the timing of past events retrieved from the memory 116, and/or databases 120, the correlation module 306 may be able to predict the users' behavior (e.g. selections) in response to present actions or activities of a nature similar to those having occurred during the past events.

In some embodiments, the correlation module 306 may apply a probabilistic model (e.g. with normal distribution), which may take into account the game clock information obtained from the content data. For instance, the content data may be indicative of a previous pace at which the event clock has been running since the beginning of the event. Alternatively, the content data may be indicative of a previous pace at which the event clock has been running for past events of a nature similar to the current event. Using the previous pace, the correlation module 306 may then determine a probability that the current pace of the event clock will vary (i.e. that the event clock will run at a faster or slower pace) or remain the same provided the event clock keeps running. This may enable the correlation module 306 to further predict a likelihood that certain actions or activities will occur during the course of the event and forecast the users' behavior in response to the predicted actions or activities. For instance, the correlation module 306 may determine that a present sports game currently presented at the venue is running at a same pace as a previous sports game previously presented at the venue, both the present and previous sports game involving the same teams. Using the previous correlations, e.g. the past selections made by users during a course of the previous sports game, the correlation module 306 may then forecast (e.g. with a given probability) that similar selections will be made during the present game.

The service data analysis module 404 may obtain service data for each entry of the retrieved selection data. The service data may comprise a label of each selected venue service and correlation of the service data may enable the service data analysis module 404 to identify the venue services selected by the patrons during the event. This may further provide an indication as to which venue services are more popular among patrons. The analysis effected by the service data analysis module 404 may further be used by the product data analysis module 406 for gaining deeper knowledge of the correlation between the various services offered at the venue and patron consumption. The product data analysis module 406 may indeed obtain product data for each entry of the retrieved selection data. The product data may for example comprise an identification, e.g. name, brand, size, nutritional value, price, etc., of products offered for a given venue service. The product data analysis module 406 may then analyze and compare the retrieved product data with the service data analysis to acquire a cognitive understanding of consumer habits at the venue. Results of the correlation performed by the product data analysis module 406 may for example indicate that after selecting a product offered by a first venue service, e.g. viewing information about teams and players using the event information service, patrons are more inclined to select another product of a second venue service, e.g. purchase sports memorabilia from the fan store service. The product analysis module 406 may also analyze the product data to obtain information as to what types of products are more often purchased or viewed by patrons, the number of purchased units for any given product, the brands most purchased, and the like.

The action data analysis module 408 may similarly obtain action data for each entry of the retrieved selection data. As discussed above, this action data may indicate the action, e.g. ordering, viewing, participating, or the like, associated with each selection made by the patron. From the action data, the action data analysis module 408 may determine that after a given number of a first action, e.g. three (3) purchases, for a given service patrons tend to perform a similar or completely different action, e.g. solely view, when accessing another service. This may mean that patrons are not inclined to make more than a fixed number of purchases while at the venue. The action data analysis module 408 may further determine what types of actions patrons tend to perform for each venue service as well as what actions are most often performed by patrons.

User data, e.g. the username associated with the patron's profile, may further be obtained from the retrieved selection data by the user data analysis module 410. From the user data, the user data analysis module 410 may then gain access to information, which the patron may have agreed to share for analysis purposes. For example, the user data analysis module 410 may be able to retrieve from the memory 116 and/or databases 120 demographics (e.g. age, gender), location, and other relevant information or attributes (e.g. interests) associated with the retrieved username. Examples of the attributes include, but are not limited to, income, job status, employment (hours performed, industry, etc.), children, siblings, and family members, studies (completed or ongoing), ethnicity/race, status (e.g. single, married, divorced), primary languages, place of birth, health status, residential are (urban, rural, etc.), credit rating, credit card usage, internet usage, online purchases, computer/mobile devices/software/smartphone and applications usage and purchases, entertainment/sports products and services consumption (spending habits, tickets, merchandising, music, goods etc.).

The location information may comprise information related to a geographical area the user resides in. In this case, the location information may comprise, but is not limited to, an address, a country, a state, and a postal code for the user. The location information may further comprise information related to the unique physical space (e.g. seat) assigned to the user in the venue. In this case, the location information may comprise, but is not limited to, the seat, row, and/or section number.

It should be understood that the user location may be obtained using a positioning system, e.g. Global Positioning System (GPS) system, or other localization techniques known to those skilled in the art. In one embodiment, the seats of the venue may be equipped with transmitters and/or receivers (not shown), using any suitable communication technology, such as Wi-Fi or the like, as indicated in equipment characteristics provided in the venue data. When such transmitters and/or receivers are provided, they may each be coded so as to be uniquely matched to the identifier of the user to which the corresponding seat has been assigned. Each transmitter may then output to a suitable receiver (not shown) provided at the venue a signal comprising the identifier of the user assigned to the seat in question. It should be understood that any given seat may be equipped with both a transmitter and a receiver. It should also be understood that the transmitters/receivers may be provided at places other than the venue seats, e.g. at an entrance of the venue, to enable localization of users when the latter are not at their seats. The transmitter may then send a transmit signal, such as a “ping” signal or the like, towards the receiver, which upon receiving the transmit signal outputs a return signal to the transmitter. The return signal illustratively comprises data confirming coordinates of the receiver. Alternatively, triangulation may be used to determine coordinates. The localization of all users in the venue can then be obtained.

Using such location information, it may be possible to establish correlations between the users' consumption of venue products and activities occurring during a course of the event. For instance, using transceivers provided at the venue entrance, it may be possible to track the movements of users in and out of the venue. This location information may be correlated with the timing of the event to determine one or more activities or actions leading to such movement. For example, it may be determined that users tend to leave the venue after occurrence of certain actions related to the event, e.g. a given sports team's score lagging behind.

The user information may then be used by the user data analysis module 410 for correlation purposes. For instance, it may be determined which types of products a given demographic group, e.g. men, women, children, or elders, tends to select from a given venue service subsequently to having selected another product from another venue service. The user data analysis module 410 may also determine from the user data that some patrons, e.g. men, tend to select a given product at a first venue service, e.g. purchase a beer product from the concession service, after having selected another product at a second venue service, e.g. viewing replay footage through the live content service. It may also be possible to determine what types of products are usually selected by patrons from a given geographical area. When tickets for the event are purchased in advance of the event or at any other time, e.g. by a corporate entity, the user data may further comprise information about the entity having purchased the tickets. Such information may be obtained by the system 102 from a ticket issuer. In this case, analyzing the user data may provide a further indication as to the type of consumer market for the events presented at the venue.

By correlating the user data with the associated information retrieved from the memory 116 and/or databases 120, the user data analysis module 410 may further determine the demographics and/or consumption trends of users present in specific areas or zones of the venue (e.g. groups of seats, rows, and/or sections). For example, using the user data analysis module 410, it may be determined that that selections for given venue products are most likely made by users present in a given section of the venue. It may be further determined that users present in the given section of the venue are predominantly young adults between the ages of 18 and 25. Using this information, it may then be possible to develop marketing efforts (e.g. advertising, promotions, product offers) specifically targeted to specific audiences identified by the user data analysis module 410. In one embodiment, the content presented on the devices 104_{P} may be tailored in accordance with the user data (e.g. attributes provided in the user profile, as described above). For instance, if the user data indicates that the user having made the selection is under a legal drinking age, the beverages presented for the concession service on the user's device 104_{P} may not comprise alcoholic beverages.

Each one of the modules 402, 404, 406, 408, and 410 may also retrieve the content data from the content provider 110 and/or from the databases 120 in order to perform the analysis and correlation discussed above. In particular, by correlating the timestamp, service, product, action, and user data to the content data, the correlation module 306 may be able to determine the relationship or impact on consumption at the venue of presentation of the content to the patrons. In particular, each module 402, 404, 406, 408, and 410, upon retrieving the content data, may determine therefrom a timing of the content presented to the patrons on their devices 104 and/or at the venue. The impact of the timing of the content on the patrons' consumption may therefore be assessed, as discussed above. For example, it may be determined that patrons tend to access concession services and purchase more food/beverage products during intermissions. It may also be inferred from the retrieved data that patrons tend to view other information, e.g. interactive content, such as games, or partake in chatroom discussions during lulls in the action.

The analysis results output by each module 402, 404, 406, 408, or 410 may be sent to any or all of the remaining modules 402, 404, 406, 408, and 410 as well as directly to the output module 208. It should be understood that a variety of correlations may be performed by each one of the analysis modules 402, 404, 406, 408, and 410 and that the correlations and analyses are not limited to those described and illustrated herein.

The correlation information generated by at least one of the timestamp data analysis module 402, service data analysis module 404, the product data analysis module 406, the action data analysis module 408, and the user data analysis module 410 may also be sent to the insight generation module 412. The insight generation module 412 may then use the received data to determine suitable actions, if any, to be taken for achieving targeted content and/or product offering. In one embodiment, the analysis results may be indicative of demographics, traits and behavioral characteristics of the audience at the venue, as discussed above. The insight generation module 412 may then use the correlation information to suggest targeted content, products, and/or services for presentation to the audience. In particular, the analysis results may be indicative of a relationship between selection of a first product offered by a first venue service and selection of a second product offered by a second venue service has been determined. Using this information, the insight generation module 412 may then determine the suitable actions to be taken given the relationship between request for the first and second product.

For example, the results of the analysis performed by the timestamp data analysis module 402 may indicate that the timing of presentation of advertising and promotions should be adjusted so that more advertising is presented during a certain timespan after occurrence of a given action during the course of the live event. For instance, the results of the analysis performed by the timestamp data analysis module 402 may indicate that, several minutes after a goal, users typically request access to the replay service for viewing a replay of the goal on their devices 104_{P} The insight generation module 412 may then generate insight data indicating that, in order to reach the largest audience, advertisements should be presented on the devices 104_{P} several minutes after a goal occurs. The analysis results may also indicate that users tend to order beer products while or after accessing the replay service. Thus, the insight generation module 412 may then generate insight data indicating that the requests for beer products is typically impacted by requests to the replay service and that it may be desirable to adjust (e.g. increase the number of) the beer product offerings in accordance with a timing of the replays.

The insight generation module 412 may also determine the type of content most suitable to be presented on the devices 104_{P} at any given moment during the course of the even. For instance, results of the analysis performed by one or more of the modules 402, 404, 406, 408, and 410 may indicate that users tend to request viewing of motorcycle advertisements after a rock song has been played. As such, the insight generation module 412 may generate insight data indicating that, after a rock song has been played, it may be desirable to select motorcycle advertisements rather than perfume advertisements for presentation on the devices 104_{P}.

Also, the analysis results received at the insight generation module 412 may allow the latter to determine whether it may be fitting to adjust the types and/or amounts of products/services offered by the venue services, particularly after occurrence of certain actions. For example, the insight generation module 412 may determine that the number of beer products offered for purchase after a rock song has been played should be increased, as users tend to select such items for purchase more often after a rock song. The insight data generated by the insight generation module 412 may also indicate that it may be desirable to refill the inventory of beer products after a rock song has been played. The insight data may further indicate that it may desirable for the fulfillment facility (reference 108 in FIG. 1) to optimize its workforce (e.g. increase the number of delivery personnel) after the rock song has been played as more orders are expected to occur then.

It should be understood that, based on the analysis results provided thereto, the insight generation module 410 may determine a variety of courses of actions to be taken. As such, various insight data may be generated and the insight data is not limited to the examples described herein. As discussed above, the insight data illustratively provides information about at least one action to be taken given a relationship (as determined from the analysis performed by one or more of the modules 402, 404, 406, 408, and 410) between requests for at least a first venue service and a second venue service. Once the analysis results and/or insight data are received at the output module 208, they may be formatted for transmission to the administrator devices 104_{A} using suitable communication means. In this manner, staff members associated with the fulfillment facility 108, content provider 110, and/or the venue may be provided with a better understanding of their clientele as well as gain knowledge of the correlation between the services or products they offer and the impact on user consumption. Staff members may further be provided with an indication of actions to be taken, if any, for enhancing the clients' experience at the venue given the correlation between the services or products. It may then be possible to tailor the venue offering, e.g. the timing of the presented content, so as to influence consumption habits.

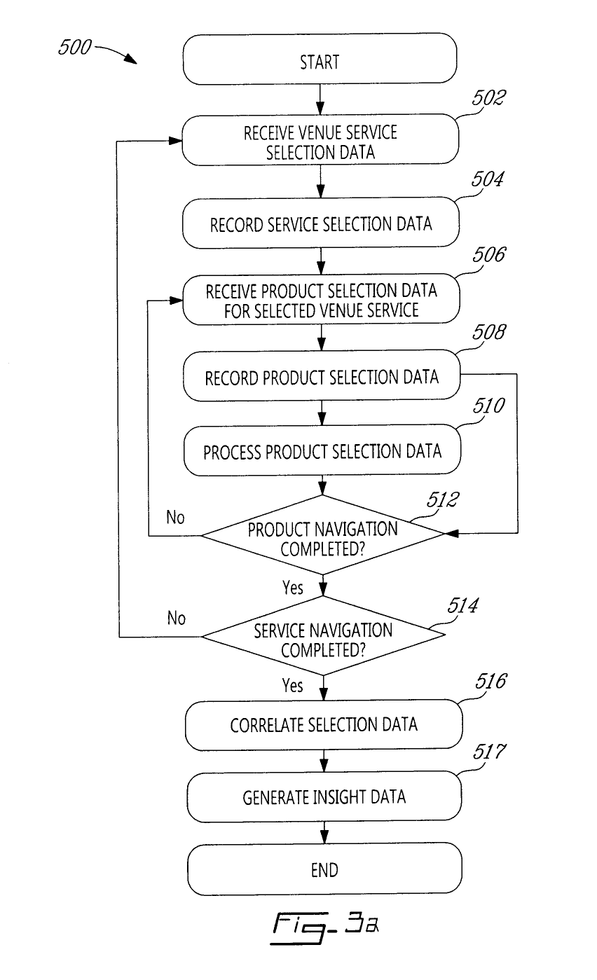

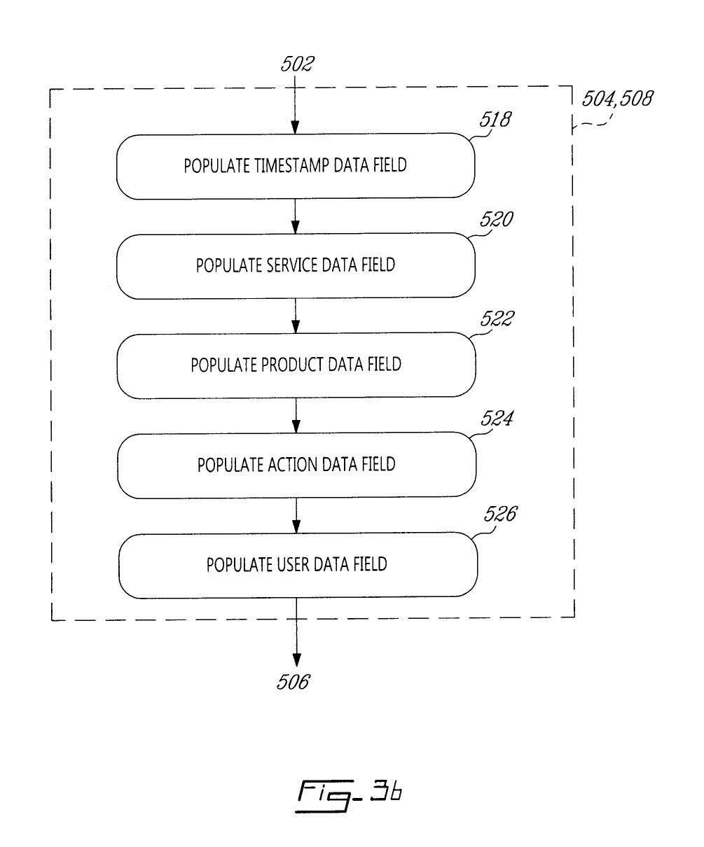

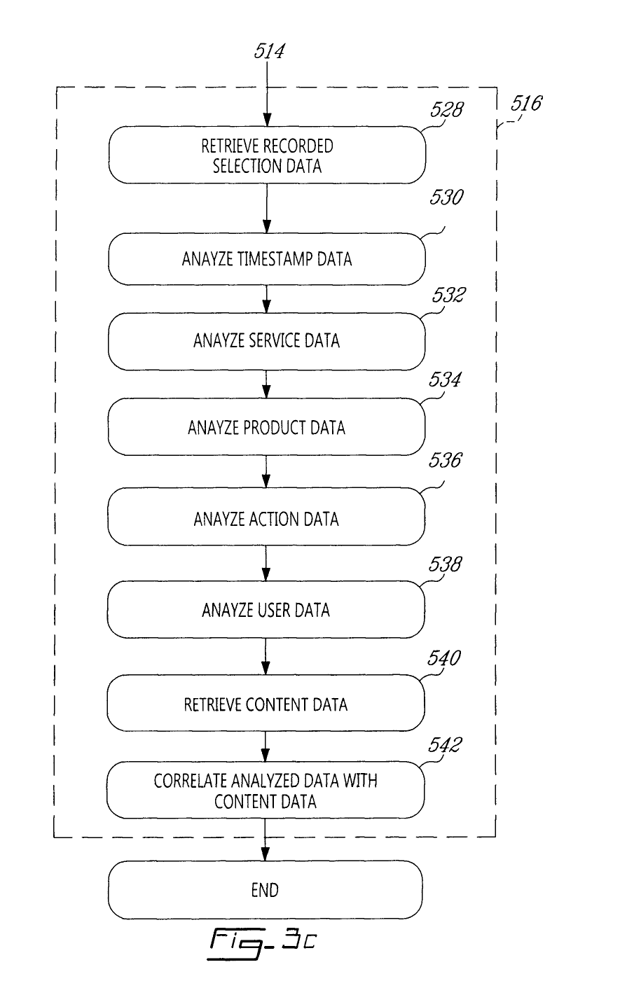

Referring to FIG. 3a, a method 500 for tracking consumer habits at a venue will now be described. The method 500 comprises receiving at step 502 venue service selection data. The service selection data may indicate a patron's selection for gaining access to a given venue service among the plurality of services available at the venue. The next step 504 may then be to record the service selection data at step 504 and receive product selection data for the selected venue service at step 506. The product selection data may indicate a patron's selection for viewing and/or ordering a given product or sub-product for the previously selected venue service. The product selection data may then be recorded at step 508. The received product selection data 508 may further be optionally processed at step 510. The processing step 510 may comprise processing the order, i.e. dispatching the order to an available fulfillment facility 108 and/or processing payment of the order.

The next step 512 may then be to determine whether product navigation, i.e. the patron's navigation among the various products available for the given venue service, is completed. The navigation may be completed if the patron has exited the presentation, e.g. the menu presented on the device 104_{P}, of the products associated with the selected venue service. The patron may exit the menu by selecting a corresponding option, e.g. an exit or return option, on their device 104_{P}. Alternatively, the navigation may be completed upon the patron closing the application launched on the device 104_{P} for accessing the system 102 or placing an order for the selected product. If product navigation is not completed, the method 500 may go back to the step 506 of receiving product selection data for the selected venue service. Otherwise, the next step 514 may be to determine whether service navigation, i.e. the patron's navigation among the various services available at the venue, is completed. Service navigation may be completed upon the patron exiting the presentation of venue services by selection a corresponding exit option on their device 104_{P} or closing the application launched on the device 104_{P} for accessing the system 102. If service navigation is not completed, the method 500 may go back to the step 502 of receiving venue service selection data. Otherwise, the selection data recorded at steps 504 and 508 may be correlated at step 516 and insight data generated at step 517 in the manner described above with relation to the insight generation module (reference 412 in FIG. 2c). It should be understood that the correlation step 516 may be performed each time selection data is received and this regardless of whether the navigation process has been completed or not.

Referring to FIG. 3b, the service selection data and the product selection data may respectively be recorded at steps 504 and 508 by populating entries in the memory 116 and/or databases. As discussed above, each entry may comprise a timestamp data field, a service data field, a product data field, an action data field, and a user data field. As such, the steps 504 and 508 of recording service and product selection data illustratively comprise populating the timestamp data field at step 518, populating the service data field at step 520, populating the product data field at step 522, populating the action data field at step 524, and populating the user data field at step 526. As discussed above, the timestamp data may comprise standard timestamp data, as indicated by a standard clock, and event timestamp data, as indicated by an event clock. The event timestamp data may comprise an indication of moments indicated by the event clock as well as an indication of a type of activities or actions having occurred at the given moments. It should be understood that the steps 518, 520, 522, 524, and 526 may be performed in any order and that at least one of the steps 518, 520, 522, 524, and 526 may be performed.

Referring to FIG. 3c, the step 516 of correlating selection data illustratively comprises retrieving at step 528 selection data previously recorded at steps 504 and 508. As discussed above, it should be understood that step 528 may be optional as data may be analyzed as it is received, without having been previously stored. The next steps 530, 532, 534, 536, and 538 may then be to respectively analyze the timestamp data, the service data, the product data, the action data, and the user data associated with the timestamp, service, product, action, and user data fields populated at steps 518, 520, 522, 524, and 526. Again, it should be understood that the steps 530, 532, 534, 536, and 538 may be performed in any order and that at least one of the steps 530, 532, 534, 536, and 538 may be performed.

The step 516 may further comprise retrieving content data at step 540 and correlating at step 542 the data analyzed at any one of steps 530, 532, 534, 536, and 538 with the retrieved content data. In this manner, as discussed above, the correlation analysis may indicate the impact of the content data, and more particularly of the timing thereof, on the consumption habits at the venue.

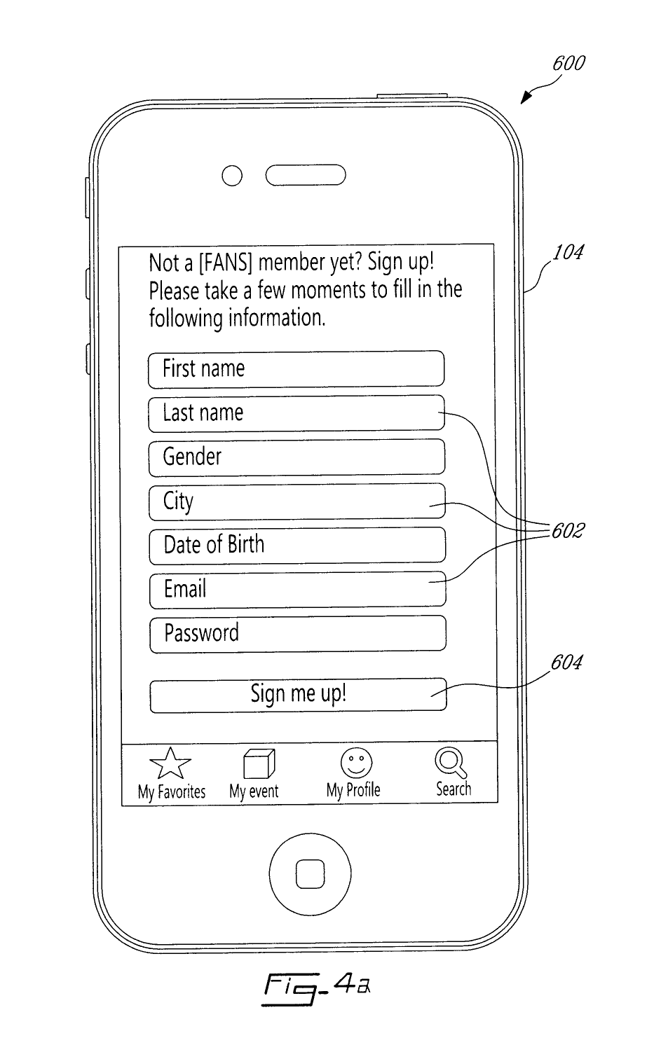

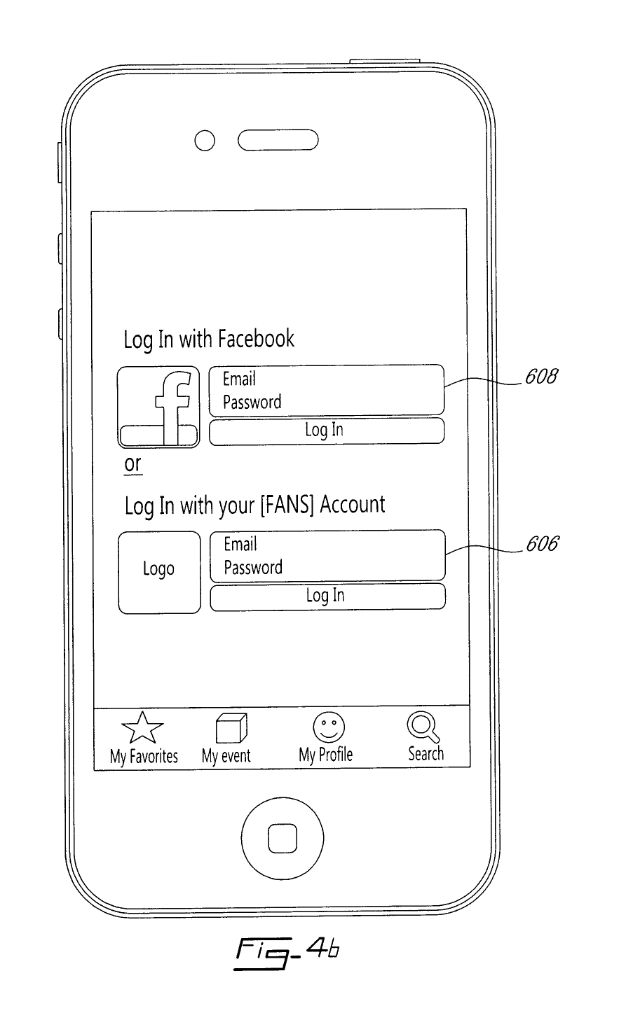

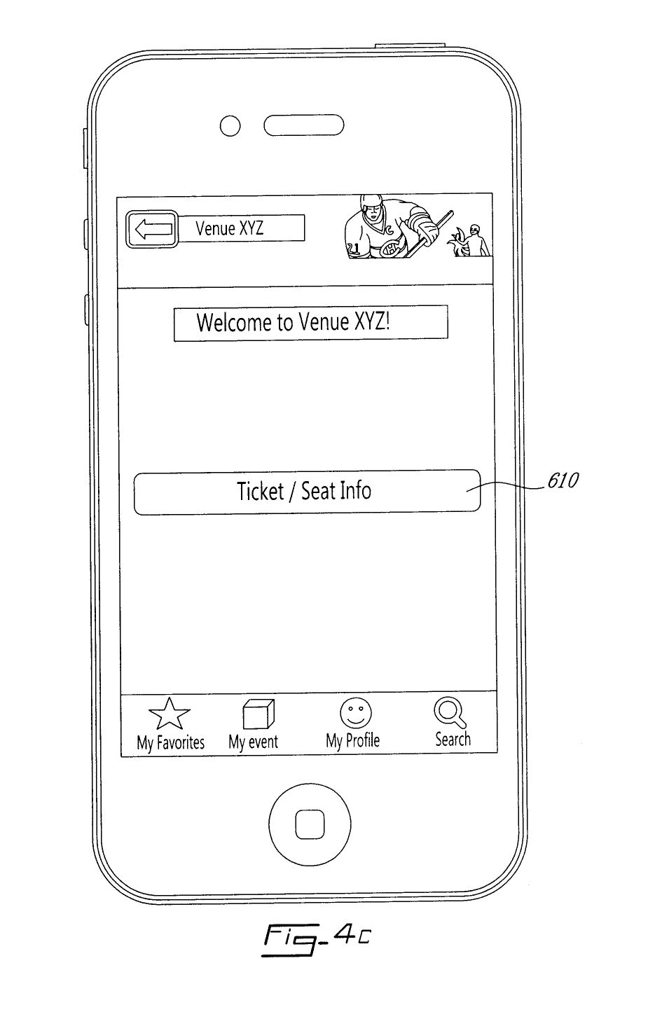

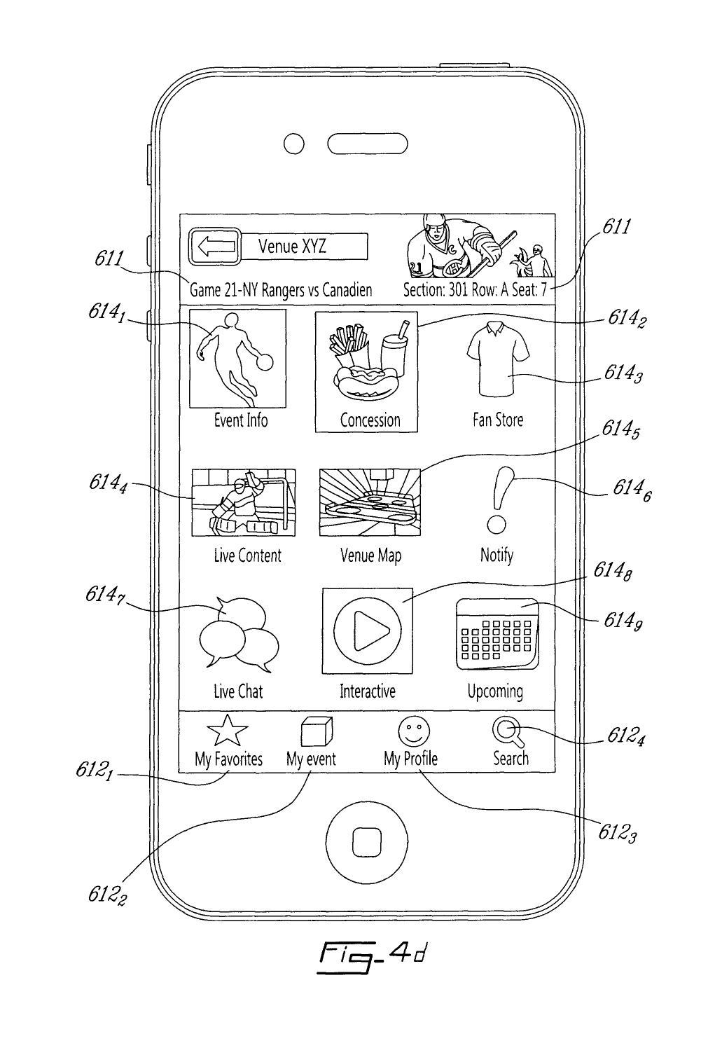

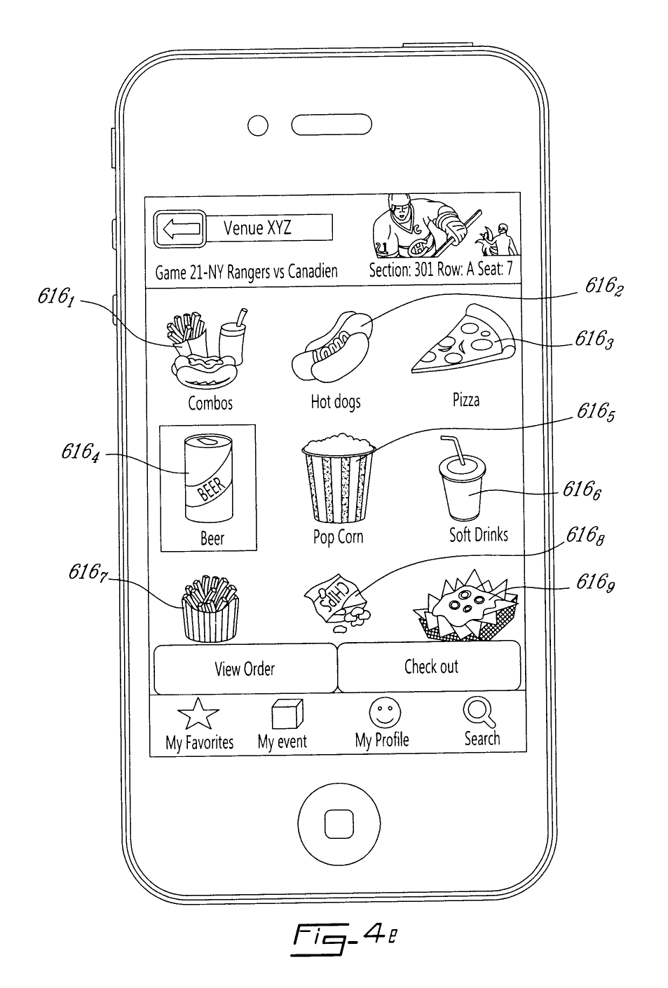

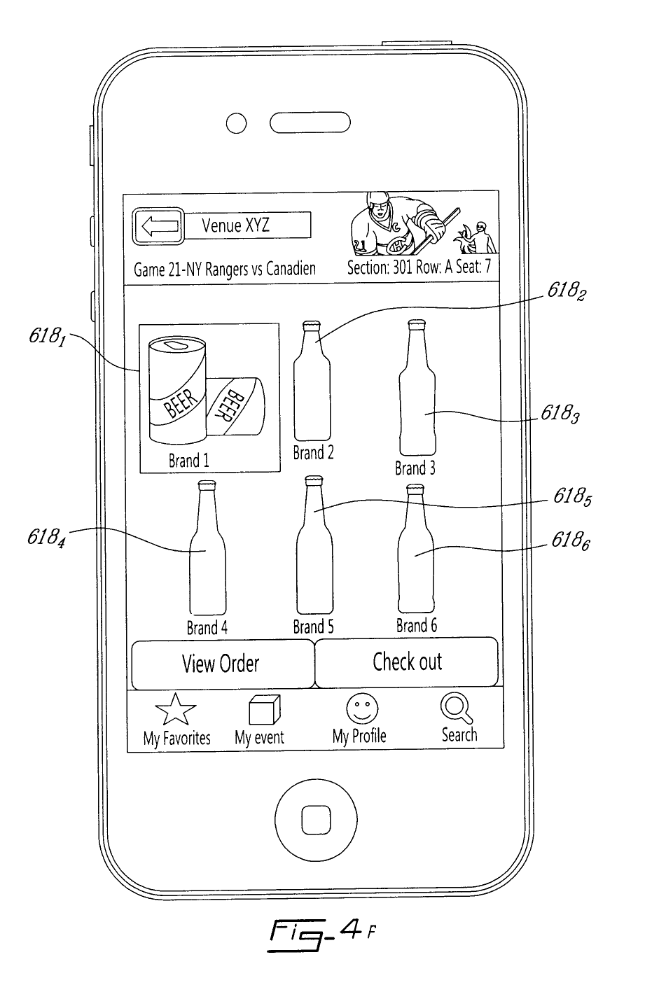

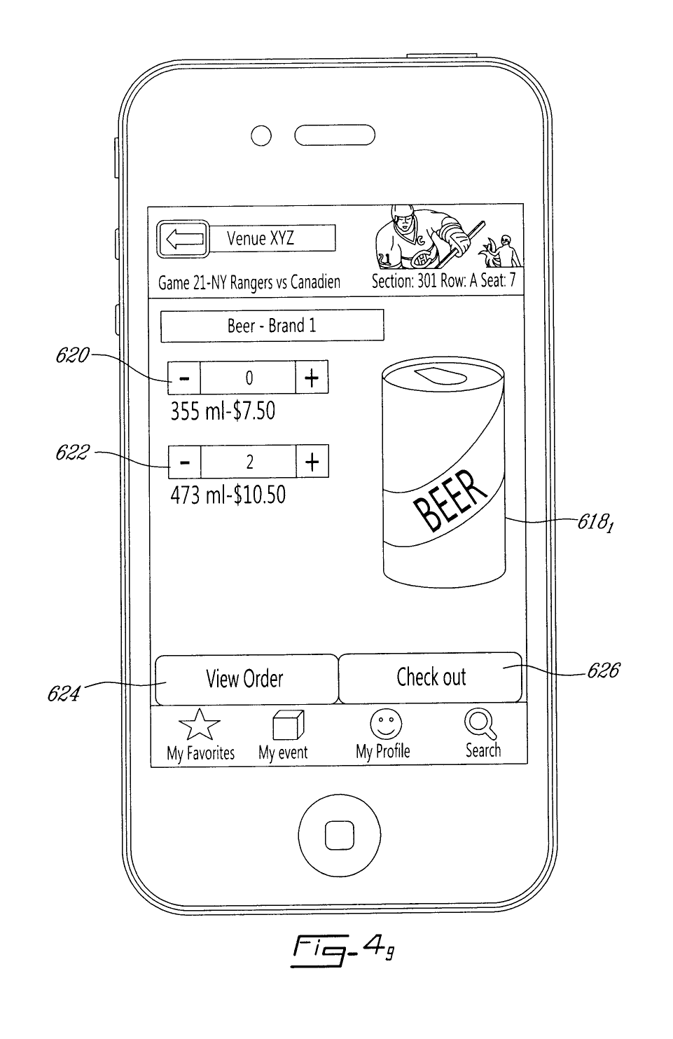

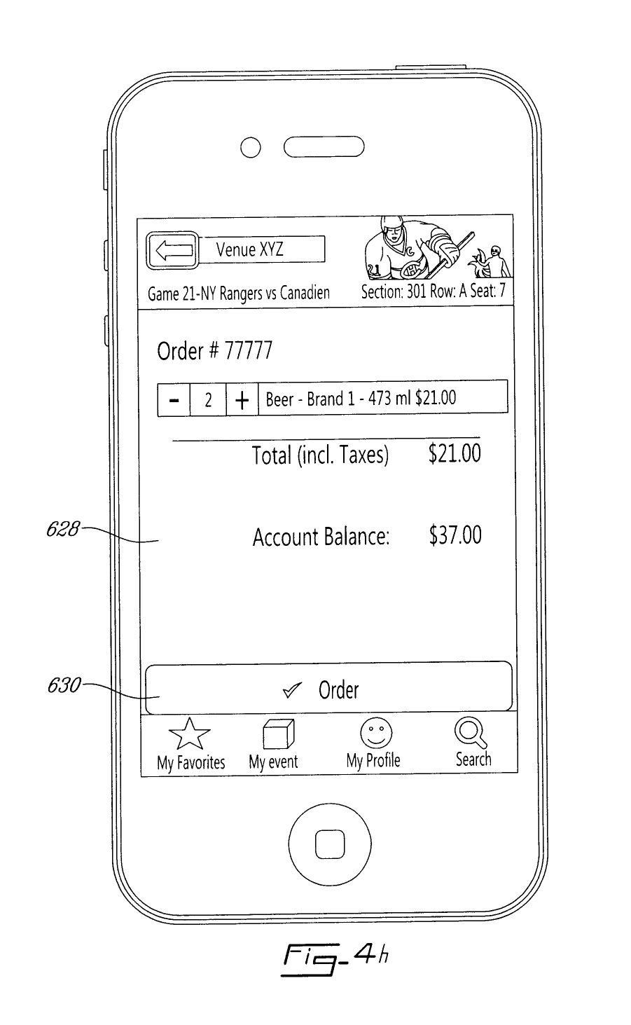

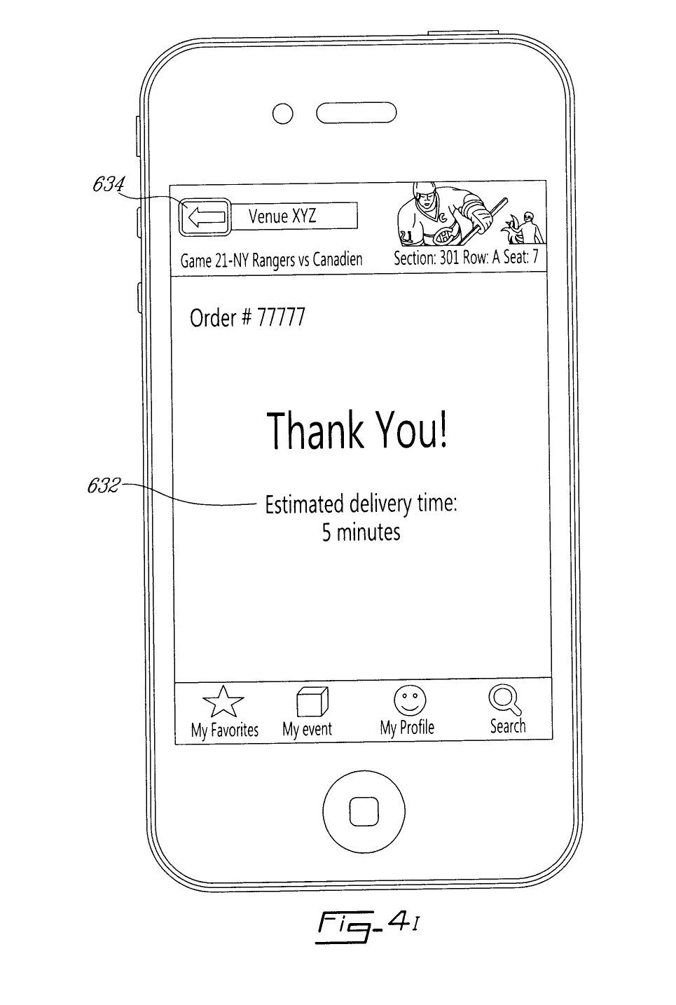

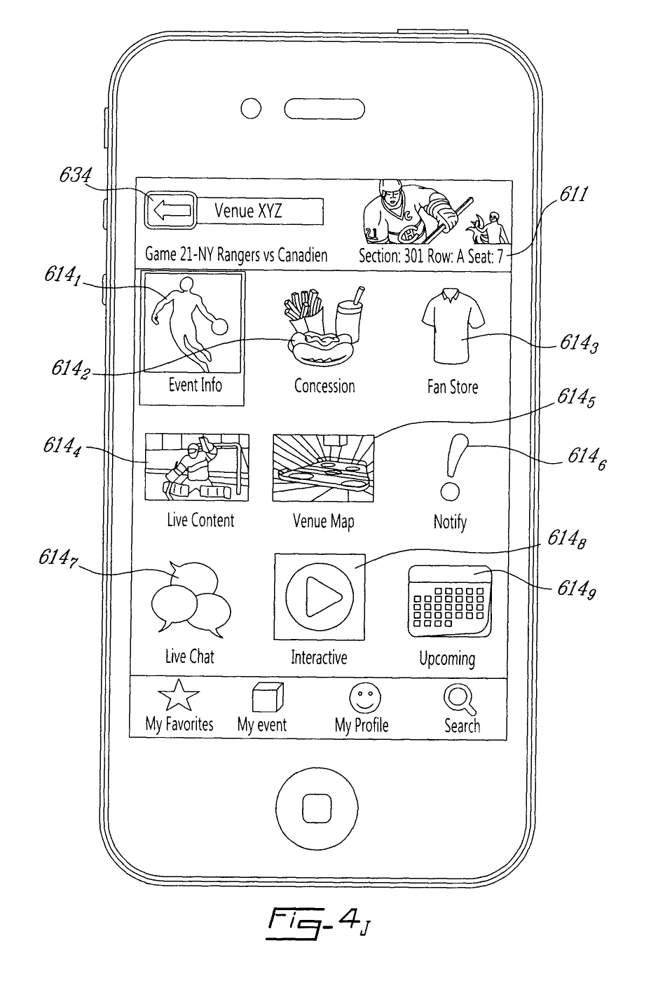

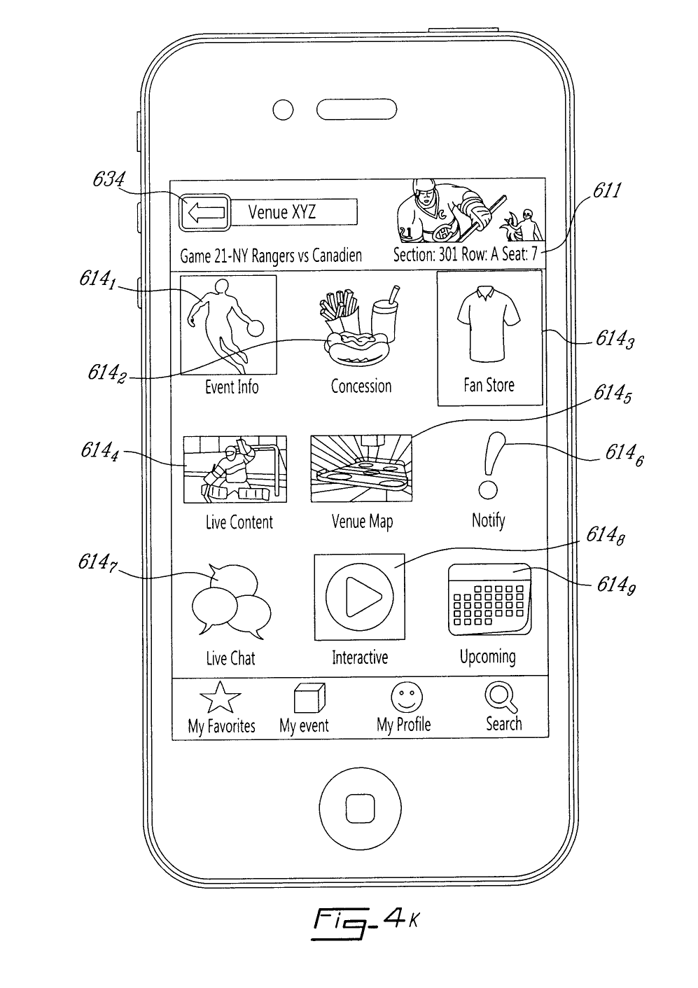

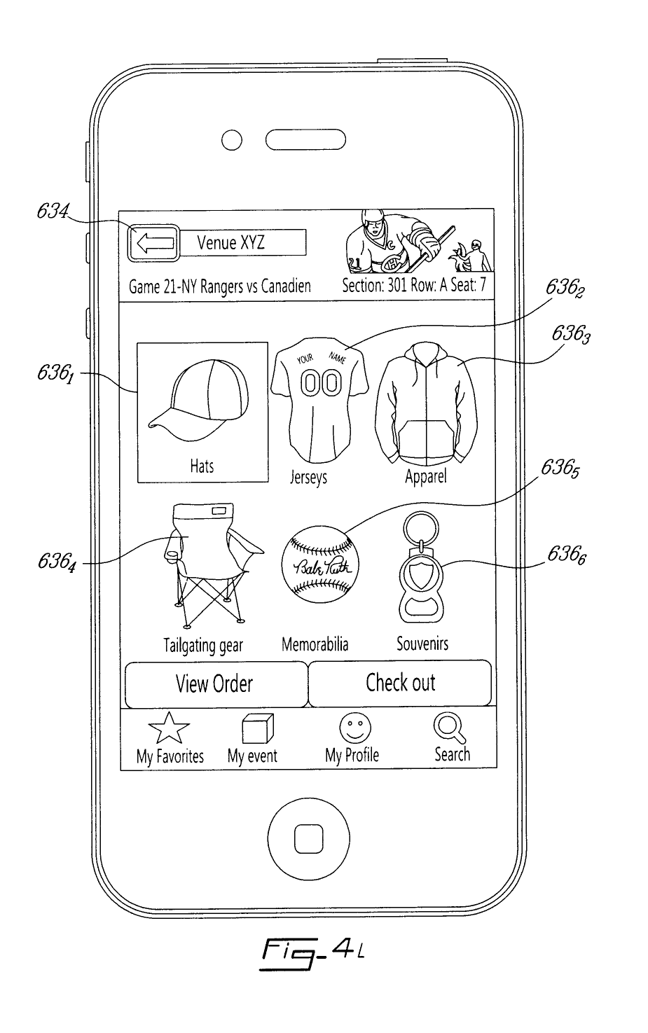

FIG. 4a illustrates a screen capture of a user interface 600 presented on the screen of a patron device 104_{P}. The user interface 600 illustratively comprises a user selected menu presented to the patron to enable the latter to browse information, order products, and other functionalities. As discussed above, the patrons illustratively register with the system 102 in order to access services provided at the venue. For this purpose, the user interface 600 illustratively comprises a plurality of user interface elements 602, such as text boxes allowing for lines of free text to be entered. In this manner, the patron may provide the information required for completing their application, thereby creating their unique profile. For example, the patron may enter information included, but not limited to, their name, gender, home address, email address, which may be used as the patron's username for logging into the system 102, and a password that will be associated with the patron's account in the system 102. Other information, such as age or interests, may also be provided to complete the patron's profile. Once the information has been properly entered, a “Sign me up!” option 604 may be selected on the user interface 600 to submit the information.

Referring to FIG. 4b, once registration is complete and the patron's profile has been created, the patron may be prompted to log into the system 102 by the user interface 600 presenting a login interface element 606. Using such an interface element 606, the patron may enter the unique identifier, i.e. username and password, associated with their profile. As discussed above, it should be understood that patrons may log into the system 102 using an identifier associated with an online social network or social networking application (e.g. Facebook™, Google+™, Twitter™ or the like) to which the patron has subscribed. For this purpose, a corresponding user interface element 608 may be presented to the patron.

Referring to FIG. 4c, once the patron has logged into the system 102 using their identifier and selected the venue, e.g. venue XYZ, they wish to obtain services from, the patron may further be presented with an interface element 610 for providing ticket/seat information. In particular, upon selection of the interface element 610, the patron may load into the system 102 information about their ticket and/or seat number at the chosen venue. The information may be loaded by the patron scanning a portion, e.g. a barcode (one dimensional or two dimensional, i.e. a matrix barcode), or the entirety of their ticket using a suitable scanning device, e.g. a camera, coupled to their device 104_{P}. The patron may also select an electronic ticket issued by the venue. Information associated with the ticket, e.g. ticket/seat number, may then be obtained from a ticket issuer and loaded into the system 102 and/or the databases 120 further to the scanning process. The information may also be manually entered by the patron using suitable interface elements (not shown) presented on the device 104_{P}. Authentication of the patron may then be performed using the provided ticket information. In addition, the system 102 may determine from the received scanning data the patron's localization (e.g. seat, row, and/or section number) within the venue. This may be useful for optimizing the delivery of patrons' orders.

Referring to FIG. 4d in addition to FIG. 4c, once the patron has been authenticated, the ticket/seat information may be presented in fields 611 of the interface 600 along with relevant account and/or event/venue information. Indeed, the user interface 600 may present the patron with a plurality of functionalities each associated with a service offered by the system 102 and/or the content provider 110. For example, a “My Favorites” functionality 612₁, a “My Event” functionality 612₂, a “My Profile” functionality 612₃, and a “Search” functionality 612₄ may be presented as selectable icons. A patron may select one of the functionalities 612₁, 612₂, 612₃, and 612₄ using one of a variety of selection means. For example, if the screen of the device 104_{P} is a touchscreen, selection may be effected by touching on the screen an icon corresponding to a given functionality. Other selection means, such as a mouse, a keyboard, a pointing device, and the like (not shown), coupled to the device 104_{P} may also be used by the patron to select any desired icon presented on the user interface 600. Also, a variety of screen selection/manipulation means other than icons, e.g. tabs, buttons, and the like, may apply.

The “My Favorites” functionality 612₁ may, upon being selected, provide the patron with information about their favorite artists, entertainers, teams, and the like, as indicated in the patron's profile. The “My Event” functionality 612₂ may, upon being selected, provide the patron with information about the list of venues the patron may log into using the system 102, as indicated in the patron's profile. It should be understood that the list of venues may be acquired on the basis of the patron's localization obtained using a positioning system, e.g. Global Positioning System (GPS) system, or other localization techniques known to those skilled in the art. The list of venues may, for example, comprise all venues within proximity of the patron's home address. The “My Profile” functionality 612₃ may, upon being selected, provide the patron with information about their profile. Using the functionality 612₃, the patron may for instance view their account balance and load money into their account using electronic payment solutions and/or redeemable vouchers. The “Search” functionality 612₄ may, upon being selected, enable the patron to search the memory 116 and/or databases 120 for information about artists, entertainers, teams, venues, services provided by the system 102, and the like. The search results may then be added to the patron's favorites using the “My Favorites” functionality 612₁ or the “My Event” functionality 612₂.

Information pertaining to the various services available in relation with the venue and/or the event may further be presented on the interface 600. For example, a main menu may display a plurality of icons each associated with the available services, such as an “Event Info” icon 614₁, a “Concession” icon 614₂, a “Fan Store” icon 614₃, a “Live Content” icon 614₄, a “Venue Map” icon 614₅, a “Notify” icon 614₆, a “Live Chat” icon 614₇, an “Interactive” icon 614₈, and an “Upcoming” icon 614₉. Upon selection of one of the icons 614₁, 614₂, 614₃, and 614₄, the patron may then be presented with sub-menus detailing the corresponding service.

The “Event Info” icon 614₁ may be used to obtain information, e.g. tour information, biography of artists, song lyrics, sports teams and player information, statistics, rankings, etc., about the event occurring at the venue. The “Concession” icon 614₂ may be used for patrons to order and pay for food and beverages using the device 104_{P} Patrons may then pick up their order or have it delivered to their location, e.g. to their seat. The “Fan Store” icon 614₃ may be used to access a catalogue of merchandise, e.g. sports apparel, jerseys, and other fan gear, related to the venue or the event. The patron may then order, pay, and pick-up the merchandise at a main store or have it delivered to their location. The “Live Content” icon 614₄ may be used to receive live content, e.g. news feeds, highlights, replays, and exclusive content, about the event in real time. The “Venue Map” icon 614₅ may be used to view an interactive map of the venue and thereby locate seats, concessions, merchandising stands, nearest exits, restrooms, special zones, and the like. The “Venue Map” icon 614₅ may also be used by the patron to localize his/her social network friends present at the venue. The “Notify” icon 614₆ may provide text entry space to enable patrons to report incidents, request assistance in case of an emergency or other event, ask questions, and the like. The “Live Chat” icon 614₇ may be used to enable patrons to communicate with moderators or venue organizers in a simulated discussion. In this manner, patrons may be provided with information about the venue and/or event at any point during the event, such as during intermissions. The “Interactive” icon 614₈ may be used to view interactive content, such as games, contests, quizzes, live surveys, and the like, provided by the content provider 110. The “Upcoming” icon 614₉ may be used to obtain information about upcoming events at the venue. The “Upcoming” icon 614₉ may also be used to purchase tickets for these upcoming events through a ticketing platform associated with the venue or the event.

It should be understood that the label, number, placement, order, and format of at least the icons 612₁, 612₂, 612₃, 612₄, 614₁, 614₂, 614₃, 614₄, 614₅, 614₆, 614₇, 614₈, and 614₉ may vary depending on the content, products, and services offered at the venue. Also, the main menu may be tailored to the preferences of the patron, as indicated in their profile. Examples of additional venue services comprise, but are not limited to, concession services, fan store or fan club services, season ticket holder services, event information, live content, venue map, interactive content, live chat, upcoming events, notification services, social media integration, localization of social network friends present at the venue, parking management, suite management, fan cam, fundraising, charity lottery, silent auctions, loyalty programs, badges or ticket history, fine dining reservation services, gaming marking, and statistics. Using their devices 104_{P} and through their online social network or social networking application, patrons may recommend and/or share with other users any content, product, or service associated with the icons 614₁, 614₂, 614₃, 614₄, 614₅, 614₆, 614₇, 614₈, and 614₉.

Referring now to FIG. 4e in addition to FIG. 4d, the patron may first select the “Concession” icon 614₂ and this selection may be recorded as an entry in the memory 116 and/or databases 120 by the service selection recording module 302, as discussed above. Once the patron has selected the “Concession” icon 614₂, he/she may be presented with a food/beverage sub-menu detailing the food/beverage categories, e.g. hot dogs, pizza, and soft drinks, available at the venue. Each food/beverage category may be represented by a corresponding icon 616₁, 616₂, 616₃, 616₄, 616₅, 616₆, 616₇, 616₈, and 616₉. Upon the patron choosing a given food/beverage category by selecting the corresponding icon 616, information detailing the food/beverage items associated with the selected category may be presented on the device 104_{P}. In some embodiments, the number of selections that may be effected by a patron on their device 104_{P} may be limited. In some cases, the patron may indeed only be allowed to make three (3) successive selections within each food/beverage category of the concession service.

For example, referring to FIG. 4f in addition to FIG. 4e, upon the patron selecting the “Beer” icon 616₂, a corresponding “Beer” sub-menu may be presented on the device 104. In particular, the sub-menu may present the patron with a plurality of icons 618₁, 618₂, 618₃, 618₄, 618₆, 618₆, 618₇, 618₈, and 618₉ each representing a particular item of the “Beer” category. By selecting the icon 618₁ corresponding to the “Brand 1” beer, the patron may then be presented with information, e.g. size, price, etc., about that particular item. Indeed, as shown in FIG. 4g, an ordering menu may be presented on the device 104 to allow the patron to select, preview, correct, or change selected food/beverage items before submission of an order. In particular, at least one interface element 620 may be presented on the screen of the device 104_{P} to enable the patron to place an order for the selected item. At least one interface element 622 may also be presented on the screen to provide the desired information to the patron. The interface element 622 may provide information about the characteristics of the product or sub-products, if any, and the interface element 620 may enable the patron to choose the number of units to be ordered. For example, using an interface element 620, the patron may add two (2) units of 473 ml “Brand 1” beer. The patron may then opt to view details, e.g. the number of ordered items and cost, of the order by selecting a corresponding “View Order” option 624 presented on the device 104. By selecting a corresponding “Check Out” option 626, the patron may further be directed to a screen enabling him/her to indicate confirmation of the order. The ordering menu may also enable the patron to cancel the order by selecting a corresponding cancel option (not shown). The selection effected by the patron at this step may then be recorded by the product selection recording module 304 as an entry in the memory 116 and/or databases 120. For example, if the patron ordered the beer product at the end of his/her navigation, the entry may indicate that the patron selected the “Brand 1” sub-product of the “Beer” category and that the corresponding action was ordering the item.

As shown in FIG. 4h, upon completing the order and selecting the “Check Out” option 626 of FIG. 4g, the patron may be presented with a payment screen 628. The payment screen 628 may summarize order details, such as the order number, the ordered items, and the cost. If the patron has subscribed for electronic payment through their registered account, the patron's account balance may also be displayed on the payment screen 628. The patron may then select an “Order” option 630 to proceed with placement of the order. As shown in FIG. 4i, a confirmation screen 632 indicating confirmation of placement of the order may then be presented. The confirmation screen 632 may further present an estimate of the delivery time for the order. After the patron has placed an order and prior to presentation of the confirmation screen 632, a terms of service screen (not shown) may also be presented to indicate to the user the rules they agree to abide by in order to use the system 102. For example, the patron may be prompted to agree to remain at their seat until the order is delivered. The patron may also agree to share some of the information from his profile with the system 102 for analysis purposes.

Referring now to FIG. 4j, upon completing the order, the patron may wish to return to the main concession service menu or to the main venue services menu. For this purpose, the patron may select a corresponding return option 634 presented on the interface 600. Upon selecting the option 634 once, the patron may return to the main concession service menu discussed above with reference to FIG. 4e. Upon selecting the option 634 again, the patron may return to the main venue services menu shown in FIG. 4j. The patron may then again select any icon 614₁, 614₂, 614₃, 614₄, 614₅, 614₆, 614₇, 614₈, and 614₉ associated with the available venue services to obtain information and/or acquire goods. For example, the patron may select the “Event Info” icon 614₁ to obtain information about the current live event occurring at the venue. The new venue service selection may then be recorded by the service selection recording module 302 as an entry in the memory 116 and/or databases 120. An event screen (not shown) displaying the desired information may further be presented on the device 104. Any selection made by the patron in relation with the event information service may further be recorded by the product selection recording module 304. For example, if the patron selects to view information about teams and players currently involved in the live event presented at the venue, the product selection recording module 304 may record such selection.

Referring to FIG. 4k, once navigation within the event information service is done and the patron has viewed the desired information, he/she may return to the main venue services menu using the option 634. The patron may then select the “Fan Store” icon 614₃ to gain access to the merchandise catalogue for the live event. The new venue service selection may then be recorded by the service selection recording module 302. As shown in FIG. 4l, the patron may then be presented with the various products available through the fan store service. For example, a “Hats” icon 636₁, a “Jerseys” icons 636₂, an “Apparel” icon 636₃, a “Tailgating gear” icon 636₄, a “Memorabilia” icon 636₅, and a “Souvenirs” icon 636₆ may be depicted. It should be understood that other icons may be used. Upon selecting the “Hats” icon 636₁, the patron may be provided with information about hats available for purchase through the fan store service. The patron may further place an order for a given hat sub-product. The patron's selection within the fan store service may also be recorded by the product selection recording module 304.

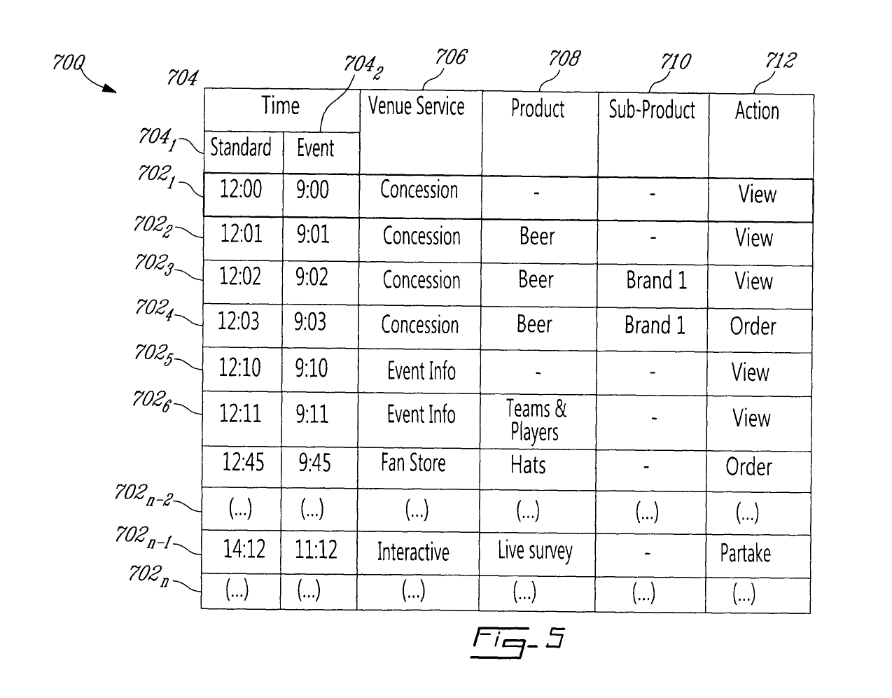

Referring now to FIG. 5, table 700 illustrates entries as in 702₁, 702₂, . . . 702ₙ corresponding to the venue service and product selection data stored during the patron's navigation discussed above with reference to FIG. 4d to FIG. 4l. Each entry as in 702₁ illustratively comprises a timestamp field 704 comprising a standard time field 704₁ indicating the standard time (with reference to a standard clock) at which the patron's selection has been received at the system 102. The timestamp field 704 may further comprise an event time field 704₂ indicating the event time (with reference to the event clock) corresponding to the standard time. As discussed above, the event time field 704₂ may have associated therewith an indication of the type of action having occurred at the given event time. For this purpose, data from sources external from the consumption management system (reference 102 in FIG. 1), e.g. from the content provider 110 and/or the databases 120, may be used. Each entry as in 702₁ further illustratively comprises a venue service field 706 indicating the venue service, e.g. concession service, selected by the patron, a product field 708 indicating the product, e.g. “Beer”, selected by the patron, a sub-product field 710 indicating the sub-product, e.g. “Brand 1”, if any, selected by the patron, and an action field 712 indicating the action, e.g. view, order, partake, and the like, associated with the patron's selection. As discussed above, each entry as in 702₁ may further comprise a user field (not shown) providing information about the patron having made the selection. The user data may comprise a username of the user as well as other relevant information, such as demographics or location, retrieved from the patron's profile.

As discussed above, the correlation module 306 may then correlate data provided in the fields 704, 706, 708, 710, and 712. For example, the correlation module 306 may determine that after ordering “Brand 1” beer at 12:03, the patron viewed information about teams and players using the “Event info” service at 12:11 and subsequently order a hat using the “Fan store” service at 12:45. The correlation module 306 may then conclude that patrons may be inclined to purchase items from the fan store service after having viewed information about the event and/or purchased refreshments using the concession service. The correlation module 306 may also determine from the stored selection data that, at 14:12, the patron participated in a live survey using the interactive service. The correlation module 306 may then correlate this information with the timing of the content data as retrieved from the content provider 110. From such a timing, the correlation module 306 may for instance determine that the patron participated in the live survey during a time-out in the live event. This result may then be used by staff members associated with the venue and/or the content provider 110 to time the interactive content broadcasted to the devices 104 during future live events. For example, the content provider 110 may choose to present interactive content, such as live surveys, on the devices 104 during intermissions or lulls in the action. As discussed above with reference to FIG. 2c, the correlation module 306 may reach a variety of conclusions as to the consumption habits at the venue from analyzing the recorded data.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment.

It should be noted that the present invention can be carried out as a method, can be embodied in a system and/or on a computer readable medium. The embodiments of the invention described above are intended to be exemplary only. The scope of the invention is therefore intended to be limited solely by the scope of the appended claims.

1. A system for tracking consumer habits at a public venue, the system comprising:
a memory;
a processor; and
at least one application stored in the memory and executable by the processor for
receiving an event signal comprising event data indicative of a timing of a live event occurring at the venue,
receiving, during a course of the event, a first request signal comprising first request data indicative of a first request for one of a first plurality of products offered at the venue by a first venue service,
receiving, during a course of the event, a second request signal comprising second request data indicative of a second request for one of a second plurality of products offered at the venue by a second venue service,
correlating the first request data with the second request data to establish a first relationship between the first request and the second request,
correlating at least one of the first request data and the second request data with the event data to identify at least one event activity related to the at least one of the first and the second request, the at least one event activity having occurred at the venue during a course of the event, and establish a second relationship between the at least one event activity and the at least one of the first request and the second request; and
outputting a control signal indicative of the established first and second relationships.

2. The system of claim 1, wherein the at least one application is executable by the processor for correlating the at least one of the first request data and the second request data with the event data comprising correlating the timing of the event with a time at which the at least one of the first and the second request data is received and identifying the at least one event activity accordingly.

3. The system of claim 2, wherein the at least one application is executable by the processor for correlating at least one of the first request data and the second request data with the event data to determine the at least one activity having occurred during a course of the event prior to at least one of the first and the second request being made and to determine the second relationship comprising a sequential relation between the at least one activity and at least one of the first request and the second request.

4. The system of claim 3, wherein the at least one application is executable by the processor for determining at least one action to be taken in relation to the event and in accordance with at least one of the first and the second relationship and for outputting the control signal comprising insight data indicative of the at least one action.

5. The system of claim 4, wherein the memory has stored therein a plurality of identifiers each uniquely identifying a corresponding one of a plurality of attendees at the venue and having associated therewith at least one attribute for the corresponding one of the plurality of attendees, and wherein the at least one application is executable by the processor for receiving the first request data and the second request data comprising a selected one of the plurality of identifiers, retrieving from the memory the at least one attribute associated with the selected one of the plurality of identifiers, and determining the at least one action in accordance with the at least one attribute.

6. The system of claim 4, wherein the memory has stored therein content for presentation on at least one mobile device during a course of the event, the at least one mobile device communicable with the processor and the memory over a network, and wherein the at least one application is executable by the processor for determining the at least one action comprising controlling at least one of a sequence, a timing, and a duration of the presentation of the content.

7. The system of claim 6, wherein the memory has stored therein a plurality of the content comprising at least one of an advertisement, a product offering, replay content, and interactive content and wherein the at least one application is executable by the processor for determining the at least one action comprising selecting a given one of the plurality of the content for presentation on the at least one mobile device.

8. The system of claim 1, wherein the at least one application is executable by the processor for receiving the first request data and the second request data each indicative of the request for at least one of accessing information about the corresponding one of the first and the second plurality of products and consuming the corresponding one of the first and the second plurality of products.

9. The system of claim 1, wherein the memory has stored therein past request data indicative of past requests for the one of the first and the second plurality of products and wherein the at least one application is executable by the processor for retrieving from the memory the past request data and comparing the first request data and the second request data to the retrieved past request data for identifying a pattern in the consumption of the corresponding one of the first and the second plurality of products.

10. The system of claim 9, wherein the at least one application is executable by the processor for identifying the pattern comprising at least one of a type, a number, a frequency, and a sequence of requests for the corresponding at least one of the first and the second plurality of products.

11. The system of claim 3, wherein the at least one application is executable by the processor for receiving the first request signal and the second request signal each comprising location data indicative of a location within the venue of a user having made the request and for correlating the location data with at least one of the event data, the first request data, and the second request data to determine first and the second relationship.

12. The system of claim 11, wherein the location data comprises seat location indicia uniquely identifying a selected one of plurality of physical spaces of the venue, the selected one of plurality of physical spaces uniquely assigned to the user.

13. A computer-implemented method for tracking consumer habits at a public venue, the method comprising:
receiving an event signal comprising event data indicative of a timing of a live event occurring at the venue;
receiving, during a course of the event, a first request signal comprising first request data indicative of a first request for one of a first plurality of products offered at the venue by a first venue service;
receiving, during a course of the event, a second request signal comprising second request data indicative of a second request for one of a second plurality of products offered at the venue by a second venue service;
correlating the first request data with the second request data to establish a first relationship between the first request and the second request;
correlating at least one of the first request data and the second request data with the event data to identify at least one event activity related to the at least one of the first and the second request, the at least one event activity having occurred at the venue during a course of the event, and establish a second relationship between the at least one event activity and the at least one of the first request and the second request; and
outputting a control signal indicative of the established first and second relationships.

14. The method of claim 13, wherein correlating the at least one of the first request data and the second request data with the event data comprises correlating the timing of the event with a time at which the at least one of the first and the second request data is received and identifying the at least one event activity accordingly.

15. The method of claim 14, wherein the at least one of the first request data and the second request data is correlated with the event data to determine the at least one activity having occurred during a course of the event prior to at least one of the first and the second request being made and to determine the second relationship comprising a sequential relation between the at least one activity and at least one of the first request and the second request.

16. The method of claim 15, further comprising determining at least one action to be taken in relation to the event and in accordance with the at least one of the first and the second relationship and outputting the control signal comprising insight data indicative of the at least one action.

17. The method of claim 16, wherein receiving the first request data and the second request data comprises receiving a selected one of a plurality of identifiers stored in a memory, each one of the plurality of identifiers uniquely identifying a corresponding one of a plurality of attendees at the venue and having associated therewith at least one attribute for the corresponding one of the plurality of attendees, the method further comprising retrieving from the memory the at least one attribute associated with the selected one of the plurality of identifiers, and determining the at least one action in accordance with the at least one attribute.

18. The method of claim 16, wherein determining the at least one action comprises controlling at least one of a sequence, a timing, and a duration of presentation of a content on at least one mobile device during a course of the event.

19. The method of claim 18, wherein determining the at least one action comprising selecting a given one of a plurality of the content for presentation on the at least one mobile device, the plurality of the content comprising at least one of an advertisement, a product offering, replay content, and interactive content.

20. The method of claim 13, further comprising retrieving from a memory past request data indicative of past requests for the at least one of the first and the second plurality of products and comparing the first request data and the second request data to the retrieved past request data for identifying a pattern in the consumption of the corresponding at least one of the first and the second plurality of products.

21. The method of claim 20, wherein identifying the pattern in the consumption comprising identifying at least one of a type, a number, a frequency, and a sequence of requests for the corresponding at least one of the first and the second plurality of products.

22. The method of claim 14, wherein the first request signal and the second request signal each comprise location data indicative of a location within the venue of a user having made the request, the method further comprising correlating the location data with at least one of the event data, the first request data, and the second request data to determine first and the second relationship.

23. A computer readable medium having stored thereon program code executable by a processor for tracking consumer habits at a venue, the program code executable for:
receiving an event signal comprising event data indicative of a timing of a live event occurring at the venue;
receiving, during a course of the event, a first request signal comprising first request data indicative of a first request for one of a first plurality of products offered at the venue by a first venue service;
receiving, during a course of the event, a second request signal comprising second request data indicative of a second request for one of a second plurality of products offered at the venue by a second venue service;
correlating the first request data with the second request data to establish a first relationship between the first request and the second request;
correlating at least one of the first request data and the second request data with the event data to identify at least one event activity related to the at least one of the first and the second request, the at least one event activity having occurred at the venue during a course of the event, and establish a second relationship between the at least one event activity and the at least one of the first request and the second request; and
outputting a control signal indicative of the established first and second relationships.
